SEQUENCE LISTING (2 sequences)

SEQ ID NO: 1 - DNA, 465 bp, Bos taurus
  source 1..465: mol_type = genomic DNA
atggggctcagcgacggggaatggcagttggtgctgaatgcctgggggaaggtggaggctgatgtcgcaggccatgggcaggaggtcctcatcaggctcttcacaggtcatcccgagaccctggagaaatttgacaagttcaagcacctgaagacagaggctgagatgaaggcctccgaggacctgaagaagcatggcaacacggtgctcacggccctggggggtatcctgaagaaaaagggtcaccatgaggcagaggtgaagcacctggccgagtcacatgccaacaagcacaagatccctgtcaagtacctggagttcatctcggacgccatcatccatgttctacatgccaagcatccttcagacttcggtgctgatgcccaggctgccatgagcaaggccctggaactgttccggaatgacatggctgcccagtacaaggtgctgggcttccatggctaa

SEQ ID NO: 2 - DNA, 465 bp, Bos taurus
  source 1..465: mol_type = genomic DNA
atgggactctctgatggtgagtggcagcttgttcttaacgcttggggaaaagtcgaggctgatgttgctggacatggacaagaggtgctcatcaggcttttcactggacatccagagactctcgagaagttcgacaagttcaagcacctcaagaccgaggctgagatgaaggcttctgaggatcttaagaagcacggcaacactgttctcactgctctcggaggaatcctcaagaagaagggacatcacgaggcagaggttaagcaccttgctgagtctcatgccaacaagcacaagatcccagtgaagtacctcgagttcatcagcgacgctattatccatgtgctccacgctaagcacccatctgattttggagctgatgctcaggctgctatgtctaaggctctcgagctgtttaggaacgatatggctgcccagtacaaggtgttgggattccatggataa

(19) United States
(12) Patent Application Publication
(10) Pub. No.: US 2023/0180812 A1
(43) Pub. Date: Jun. 15, 2023

(54) MEAT SUBSTITUTES PRODUCED IN PLANT-BASED SYSTEMS AND METHOD THEREOF

(71) Applicant: Alejandro BARBARINI, Santa Fe (AR)

(72) Inventor: Alejandro BARBARINI, Santa Fe (AR)

(21) Appl. No.: 17/913,524

(22) PCT Filed: May 23, 2021
(86) PCT No.: PCT/IL2021/050600

§ 371 Date: Sep. 22, 2022

Related U.S. Application Data
(60) Provisional application No. 62/993,088, filed on Mar. 23, 2020.

(51) Int. Cl. A23L 33/185; A23L 33/15; A23L 33/145; A23J 3/22

(52) U.S. Cl. CPC A23L 33/185; A23L 33/15; A23L 33/145; A23J 3/22

(57) ABSTRACT

The present invention provides a plant-based meat substitutes and method thereof. The present invention discloses a plant cell culture, preferably, carrot cells, which expresses transgenic bovine myoglobin proteins. This unique myoglobin-expressing culture is then transformed into a slurry, which serves as the platform for the production of the plant-based meat substitutes. Furthermore, those meat substitutes are highly nutritious, as they contain beneficial ingredients derived from the plant cells (such as beta-carotene) in addition to high protein (myoglobin) content. The application of carrot cell slurry containing myoglobin proteins to those meat substitutes provides organoleptic and physicochemical properties enhanced or similar to conventional meat products. The carrot cells expressing myoglobin proteins can be conserved in a powder form, as the plant cells successfully encapsulate the myoglobin proteins, thus protecting them from physicochemical conditions, such as spray drying.

### CROSS REFERENCE TO RELATED APPLICATIONS

This application is a National Phase of PCT Patent Application No. PCT/IL2021/050600 having International filing date of May 23, 2021, which claims the benefit of priority of U.S. Provisional Patent Application No. 62/993,088, filed Mar. 23, 2020, the contents of which are all incorporated herein by reference in their entirety.

### SEQUENCE LISTING

The instant application contains a Sequence Listing which has been submitted electronically in ASCII txt. format and is hereby incorporated by reference in its entirety. Said ASCII copy, is named txt_ALEJANDRO-BARBARINI-2400-A-01-PCT-US-CORRECTED-SEQ-LISTING and is 4 KB in size and was created on Mar. 1, 2023.

### FIELD OF THE INVENTION

The present disclosure relates to plant-based meat substitutes. More particularly, these meat substitutes are food compositions comprising the myoglobin protein expressed in plant cell cultures and characterized by enhanced nutritional values and similar organoleptic and physicochemical properties compared to conventional meat products.

### BACKGROUND OF THE INVENTION

In light of the growing population, which is estimated to reach approximately 10 billion people in the upcoming decades and given the significant climatic changes affecting yield and quality of agricultural crops, researchers attempt to create new techniques to produce more nutritious and sustainable food products, which would also be environmentally friendly and cruelty free. Such foodstuffs may base completely on plant materials (for instance, meat and milk alternatives made of plant proteins) or on animal proteins or tissues produced in laboratories (meat products referred to as ‘clean meat’ or ‘cultured meat’). Those notions have been gaining a lot of attention in recent years, as topics such as veganism and animal welfare have become increasingly popular. In fact, it is believed that in the upcoming decade, more people will increase their consumption of plant-based products, mainly cheese and meat alternatives. However, these products are still considered rather costly, and their taste and texture still does not fully resemble animal-based products.

Expression and production of commercially mass-produced proteins for the pharmaceutical and food industries have also improved in recent decades in terms of yield and functionality.

The production of heterologous proteins in bio-producers using genetic engineering and emerging biotechnological techniques is now widely used, mainly for scientific and medical purposes. Those proteins are known as ‘recombinant’ or ‘transgenic’ proteins. Currently and due to the development of biological techniques allowing to overcome interspecies barriers, a wide range of protein expression systems is utilized, including bacterial, fungal, algal, insectile, plant and mammalian cells (see “Production of Recombinant Proteins in Plant Cells”, S. V. Gerasimovaa et al., Russian Journal of Plant Physiology, 2016, Vol. 63, No. 1, pp. 26-37, 2016).

Plant-based systems are considered a valuable platform for the production of recombinant proteins as a result of their well-documented potential for the flexible, low-cost production of high-quality, bioactive products. Plant-based platforms are arising as an important alternative to traditional fermenter-based systems for safe and cost-effective recombinant protein production. Although downstream processing costs are comparable to those of microbial and mammalian cells, the lower up-front investment required for commercial production in plants and the potential economy of scale, provided by cultivation over large areas, are key advantages (see “A Comparative Analysis of Recombinant Protein Expression in Different Biofactories: Bacteria, Insect Cells and Plant Systems”, Elisa Gecchele et al., Journal of Visualized Experiments, 97, p. 1-8, 2015).

In addition, plant-based systems have numerous other advantages: (i) they are distinguished by a diversity and plasticity (varying from hairy roots and cell suspension cultures of a fixed volume and high purity to transgenic plants cultivated in large areas); (ii) they are free of dangerous pathogens and toxins found in bacterial- and mammalian-based systems; (iii) they can be cultivated under aseptic conditions using classical fermentation technology; (iv) they are easy to scale-up for manufacturing; (v) they sustain complex post-translational modifications (such as glycosylation) characteristic to eukaryotic proteins; and (vi) the regulatory requirements are similar to those established for well-characterized production systems based on microbial and mammalian cells (see “Putting the spotlight back on plant suspension cultures”, Santos Rita B. et al., Front Plant Sci.; 7:297, Mar. 11, 2016).

More specifically, plant cell suspension cultures have several additional benefits, rendering them even more advantageous in comparison to whole transgenic plants. Suspension cultures are completely devoid of risks, such as unpredicted weather conditions, pests, soil infections and gene flow from other organisms in the environment. Moreover, due to the short growth cycles of suspension cultured cells, the timescale needed to produce recombinant proteins in plant cell culture can be counted in days compared to months needed for the production in transgenic plants. In addition, growing plant cells in sterile and controlled environments, such as bioreactors, allows precise control over cell growth conditions, batch-to-batch product consistency, utilization of chemically inducible systems and more.

Similar to microbial fermentation, plant cells have relatively rapid doubling times (as fast as 16 h) and can grow in simple synthetic media using conventional bioreactors.

U.S. Pat. No. 69,167,871 to Bertrand Merot discloses a method for producing haemin proteins by inserting into plant cells one or more nucleic acid molecules, each comprising at least one sequence coding for a protein component of an animal haemin protein capable of reversibly binding oxygen (for example hemoglobin and its derivatives, and myoglobin), or for a variant or portion of said protein component, and optionally a sequence coding for a selection agent; selecting cells containing nucleic acid coding for the protein component of the haemin protein; optionally propagating the transformed cells either in a culture or by regenerating whole transgenic or chimeric plants; and recovering and optionally purifying a haemin protein that includes a complex consisting of the protein or proteins coded by said nucleic acid and at least one iron-containing porphyritic nucleus, or a plurality of such complexes.

US patent 20150305390A1 to Impossible Foods Inc. discloses methods and compositions for the production of non-meat consumable products. A meat substitute is described, constructed from a heme-containing protein which is a muscle analog, a fat analog, and a connective tissue analog selected from a group consisting of androglobin, a cytoglobin, a globin E, a globin X, a globin Y, a hemoglobin, a leghemoglobin, a flavohemoglobin, Hell's gate globin I, a myoglobin, an erythrocruorin, a beta hemoglobin, an alpha hemoglobin, a protoglobin, a cyanoglobin, a cytoglobin, a histoglobin, a neuroglobins, a chlorocruorin, a truncated hemoglobin, a truncated 2/2 globin, a hemoglobin 3, a cytochrome, and a peroxidase.

EP patent 3044320A2 to Impossible Foods Inc. discloses methods and compositions for the expression and secretion of heme-containing polypeptides in a recombinant plant or plant cell. The heme-containing polypeptide is selected from the group consisting of an androglobin, a cytoglobin, globin E, globin X, globin Y, a hemoglobin, a myoglobin, a leghemoglobin, an erythrocruorin, a beta hemoglobin, an alpha hemoglobin, a non-symbiotic hemoglobin, a flavohemoglobin, a protoglobin, a cyanoglobin, a Hell's gate globin I, a bacterial hemoglobin, a ciliate myoglobin, a histoglobin, a neuroglobin, a protoglobin and a truncated globin.

In view of the prior art and given the various challenges described above, there is still an unmet long-felt need for plant-based meat substitutes and method thereof, characterized by enhanced nutritional values and organoleptic and physicochemical properties similar to conventional meat products.

### BRIEF DESCRIPTION OF THE FIGURES

The accompanying drawings, which are included to provide a further understanding of the invention and are incorporated in and constitute a part of this specification, illustrate embodiments of the invention and together with the description serve to explain the principles of the invention.

FIG. 1 schematically depicting the method for producing myoglobin-expressing plant cell suspension powder and slurry for manufacturing the meat substitutes of the present invention; and

FIG. 2 schematically depicting the method for producing the plant-based meat substitutes of the present invention.

### SUMMARY OF THE INVENTION

It is one object of the present invention to disclose a plant-based meat substitute comprising:
a. a slurry of transgenic plant cells expressing at least one form of hemoprotein;
b. yeast extract;
c. at least one acid;
d. at least one vitamin;
e. at least one salt;
f at least one plant protein;
g. at least one saccharide;
h. at least one type of plant fibers;
i. at least one vegetable oil; and
j. at least one food additive,
   wherein said plant-based meat substitute characterized organoleptic and physicochemical properties characteristic of meat products of animal origin.

It is another object of the present invention to disclose the plant-based meat substitute of the above, wherein said at least one form of hemoprotein is selected from a group consisting of hemoglobin, myoglobin, neuroglobin, cytoglobin, leghemoglobin and any combination thereof.

It is another object of the present invention to disclose the plant-based meat substitute of the above, wherein said transgenic plant cells are selected from a group consisting of cell suspension cultures, hairy root cultures, transgenic plants and any combination thereof. It is another object of the present invention to disclose the plant-based meat substitute of the above, wherein said transgenic plant cells are selected from a group consisting of carrot cells, rice cells, beetroot cells, tobacco cells, potato cells, sweet potato cells, tomato cells, Arabidopsis cells, Nicotiana benthamiana cells, cassava cells, kohlrabi cells, parsley cells, horseradish cells, jackfruit cells, Anchusa officinalis cells and any combination thereof.

It is another object of the present invention to disclose the plant-based meat substitute of the above, wherein said transgenic plant cells are carrot cells.

It is another object of the present invention to disclose the plant-based meat substitute of the above, wherein said at least one acid is selected from a group consisting of acetic acid, succinic acid, ascorbic acid, citric acid, lactic acid, malic acid, tartaric acid and any combination thereof.

It is another object of the present invention to disclose the plant-based meat substitute of the above, wherein said at least one vitamin is selected from a group consisting of thiamine, niacin, riboflavin, nicotinamide, pantothenic acid, pyridoxine, folate biotin, vitamin B12 and any combination thereof.

It is another object of the present invention to disclose the plant-based meat substitute of the above, wherein said at least one salt is selected from a group consisting of sodium salts, zinc salts, copper salts, magnesium salts, potassium salts, manganese salts and any combination thereof.

It is another object of the present invention to disclose the plant-based meat substitute of the above, wherein said at least one plant protein is selected from a group consisting of textured vegetable proteins, isolated plant proteins, cashew, almonds, peanuts, walnuts, brazil nuts, rice, wheat, oat, rye, corn, quinoa, lentil, sesame, chia, pea, chickpea, lupine, soybean, fava bean, mung bean, pumpkin seeds, sunflower seeds, flaxseeds, potato, cassava, yam and any combination thereof.

It is another object of the present invention to disclose the plant-based meat substitute of the above, wherein said at least one saccharide is selected from a group consisting of starch, sucrose, dextrose, maltodextrin, fructose, glucose, pectin, steviol and any combination thereof.

It is another object of the present invention to disclose the plant-based meat substitute of the above, wherein said at least one type of plant fibers is selected from a group consisting of cellulose, bamboo fibers, flaxseed fibers, banana fibers, Abaca fibers, jute fibers, sisal fibers, pineapple fibers, pea fibers, apple fibers and any combination thereof.

It is another object of the present invention to disclose the plant-based meat substitute of the above, wherein said at least one vegetable oil is selected from a group consisting of coconut oil, canola oil, corn oil, olive oil, cottonseed oil, palm oil, peanut oil, sesame oil, soybean oil, sunflower oil and any combination thereof.

It is another object of the present invention to disclose the plant-based meat substitute of the above, wherein said at least one food additive is selected from a group consisting of stabilizers, emulsifiers, anticaking agents, salts, yeast extract, flavorings, antifoaming agents, antioxidants, bulking agents, colorants, humectants, preservatives, sweeteners, vitamins, antioxidants, hydrocolloids, thickeners and any combination thereof.

It is another object of the present invention to disclose the plant-based meat substitute of the above, wherein said antioxidants are tocopherols selected from a group consisting of alpha tocopherol, beta tocopherol, gamma tocopherol, delta tocopherol, synthetic tocopherol and any combination thereof.

It is another object of the present invention to disclose the plant-based meat substitute of the above, wherein said flavorings are selected from a group consisting of paprika, black pepper, white pepper, turmeric, herb blends, Baharat, Cajun seasoning, chimichurri blend, Garam Masala, Ras el-hanout, curry, gumbo powder, harissa, zaatar, cumin, berbere, Adobo Seasoning, chili, BBQ seasonings, breadcrumbs, glucose, ribose, cysteine, succinic acid, dextrose, sucrose, thiamine, glutamic acid, alanine, arginine, asparagine, aspartate, glutamine, glycine, histidine, isoleucine, leucine, lysine, methionine, phenylalanine, proline, threonine, tryptophan, tyrosine, valine, guanosine monophosphate, inosine monophosphate, lactic acid, creatine, sodium chloride, potassium chloride and any combination thereof.

It is another object of the present invention to disclose the plant-based meat substitute of the above, wherein said substitute comprises at least 5 milligrams beta-carotene per 1 Liter.

It is another object of the present invention to disclose the plant-based meat substitute of the above, wherein said organoleptic properties are selected from a group consisting of texture, consistency, appearance, taste, odor, flavor, aroma, touch, mouthfeel and any combination thereof.

It is another object of the present invention to disclose the plant-based meat substitute of the above, wherein said physicochemical properties are selected from a group consisting of strength, firmness, tightness, resilience, rheological parameters, moisture content, viscosity, hardness, adhesiveness, cohesiveness, fracturability, elasticity, chewability, springiness, degradation rate, solvation, porosity, electrical charge and any combination thereof.

It is another object of the present invention to disclose the plant-based meat substitute of the above, wherein said substitute is steak substitute, meatloaf substitute, schnitzel substitute, entrecote substitute, sausage substitute, hot dogs substitute, pastrami substitute, shish kebab substitute, kabab substitute, salami substitute, bacon substitute, meat balls substitute, shawarma substitute, hamburger substitute, patty substitute, kabanos substitute, jerky substitute, ground meat substitute, roast meat substitute, minced meat substitute, pulled meat substitute, skewered meat substitute, raw meat substitute, smoked meat substitute, or grilled meat substitute.

It is another object of the present invention to disclose the plant-based meat substitute of the above, wherein said transgenic plant cells, prior to forming said slurry, are configured to be spray-dried into a plant cell powder.

It is another object of the present invention to disclose the plant-based meat substitute of the above, wherein said plant cell powder is storable without refrigeration at about 22° C.-28° C. for about 6 months.

It is another object of the present invention to disclose a method for producing a plant-based meat substitute comprising steps of:
a. genetically transforming plant cells to express at least one form hemoprotein;
b. growing said genetically transformed plant cells in a culture;
c. concentrating said plant cells;
d. resuspending said plant cells in a buffer solution;
e. spray-drying said plant cells to generate a powder;
f. storing said powder at predetermined temperature;
g. resuspending said powder in a buffer solution to obtain resuspended cells;
h. disrupting said resuspended cells;
i. obtaining a slurry of plant cells;
j. admixing said slurry of plant cells with water, yeast extract, at least one acid, at least one salt and at least one vitamin to generate a first mixture;
k. separately admixing at least one plant protein, at least one saccharide, at least one food additive and at least one type of plant fibers to generate a second mixture;
l. combining said first mixture and said second mixture to generate a third mixture;
m. separately admixing at least one vegetable oil and at least one tocopherol with water to generate forth mixture;
n. combining said third mixture with said forth mixture by means of homogenization to generate fifth mixture;
o. portioning said fifth mixture to servings; and
p. molding said servings to desired shapes and sizes,
   thereby, producing a plant-based meat substitute characterized organoleptic and physicochemical properties characteristic of meat products of animal origin.

It is another object of the present invention to disclose the method of the above, wherein said at least one form of hemoprotein is selected from a group consisting of hemoglobin, myoglobin, neuroglobin, cytoglobin, leghemoglobin and any combination thereof.

It is another object of the present invention to disclose the method of the above, wherein said genetically transformed plant cells are selected from a group consisting of cell suspension cultures, hairy root cultures, transgenic plants and any combination thereof.

It is another object of the present invention to disclose the method of the above, wherein said genetically transformed plant cells are selected from a group consisting of carrot cells, rice cells, beetroot cells, tobacco cells, potato cells, sweet potato cells, tomato cells, Arabidopsis cells, Nicotiana benthamiana cells, cassava cells, kohlrabi cells, parsley cells, horseradish cells, jackfruit cells, Anchusa officinalis cells and any combination thereof.

It is another object of the present invention to disclose the method of the above, wherein said at least one acid is selected from a group consisting of acetic acid, succinic acid, ascorbic acid, citric acid, lactic acid, malic acid, tartaric acid and any combination thereof.

It is another object of the present invention to disclose the method of the above, wherein said at least one vitamin is selected from a group consisting of thiamine, niacin, riboflavin, nicotinamide, pantothenic acid, pyridoxine, folate biotin, vitamin B12 and any combination thereof.

It is another object of the present invention to disclose the method of the above, wherein said at least one salt is selected from a group consisting of sodium salts, zinc salts, copper salts, magnesium salts, potassium salts, manganese salts and any combination thereof.

It is another object of the present invention to disclose the method of the above, wherein said at least one plant protein is selected from a group consisting of textured vegetable proteins, isolated plant proteins, cashew, almonds, peanuts, walnuts, brazil nuts, rice, wheat, oat, rye, corn, quinoa, lentil, sesame, chia, pea, chickpea, lupine, soybean, fava bean, mung bean, pumpkin seeds, sunflower seeds, flaxseeds, potato, cassava, yam and any combination thereof.

It is another object of the present invention to disclose the method of the above, wherein said at least one saccharide is selected from a group consisting of starch, sucrose, dextrose, maltodextrin, fructose, glucose, pectin, steviol and any combination thereof.

It is another object of the present invention to disclose the method of the above, wherein said at least one type of plant fibers is selected from a group consisting of cellulose, bamboo fibers, flaxseed fibers, banana fibers, Abaca fibers, jute fibers, sisal fibers, pineapple fibers, pea fibers, apple fibers and any combination thereof.

It is another object of the present invention to disclose the method of the above, wherein said at least one food additive is selected from a group consisting of stabilizers, emulsifiers, anticaking agents, salts, yeast extract, flavorings, antifoaming agents, antioxidants, bulking agents, colorants, humectants, preservatives, sweeteners, vitamins, antioxidants, hydrocolloids, thickeners and any combination thereof.

It is another object of the present invention to disclose the method of the above, wherein said flavorings are selected from a group consisting of paprika, black pepper, white pepper, turmeric, herb blends, Baharat, Cajun seasoning, chimichurri blend, Garam Masala, Ras el-hanout, curry, gumbo powder, harissa, zaatar, cumin, berbere, Adobo Seasoning, chili, BBQ seasonings, breadcrumbs, glucose, ribose, cysteine, succinic acid, dextrose, sucrose, thiamine, glutamic acid, alanine, arginine, asparagine, aspartate, glutamine, glycine, histidine, isoleucine, leucine, lysine, methionine, phenylalanine, proline, threonine, tryptophan, tyrosine, valine, guanosine monophosphate, inosine monophosphate, lactic acid, creatine, sodium chloride, potassium chloride and any combination thereof.

It is another object of the present invention to disclose the method of the above, wherein said at least one tocopherol is selected from a group consisting of alpha tocopherol, beta tocopherol, gamma tocopherol, delta tocopherol, synthetic tocopherol and any combination thereof.

It is another object of the present invention to disclose the method of the above, wherein said at least one vegetable oil is selected from a group consisting of coconut oil, canola oil, corn oil, olive oil, cottonseed oil, palm oil, peanut oil, sesame oil, soybean oil, sunflower oil and any combination thereof.

It is another object of the present invention to disclose the method of the above, wherein said genetically transforming is executed by means selected from a group consisting of the Agrobacterium-mediated transformation method, particle bombardment, injection, viral transformation, in planta transformation, electroporation, lipofection, sonication, silicon carbide fiber mediated gene transfer, laser microbeam (UV) induced gene transfer, co-cultivation with the explants tissue and any combination thereof.

It is another object of the present invention to disclose the method of the above, wherein said concentrating of said plant cells is executed by means of vacuum filtration, membrane filtration and any combination thereof.

It is another object of the present invention to disclose the method of the above, wherein said disrupting of said resuspended cells is executed by means of homogenization or mixing.

It is another object of the present invention to disclose a slurry comprising plant cells expressing at least one form of myoglobin for use in the production of foodstuffs, food ingredients and beverages.

### DETAILED DESCRIPTION OF THE PREFERRED EMBODIMENTS

The following description is provided, alongside all chapters of the present invention, so as to enable any person skilled in the art to make use of the invention and sets forth the best modes contemplated by the inventor of carrying out this invention. Various modifications, however, are adapted to remain apparent to those skilled in the art, since the generic principles of the present invention have been defined specifically to provide plant-based meat substitutes made of transgenic myoglobin proteins expressed in plant suspension cultures, and methods thereof.

As used herein, the term “about” refers to any value being up to 25% lower or greater than the defined measure.

As used herein, the term “plant-based meat substitute” refers to any consumable product, beverage or foodstuff, which is supposed to mimic the appearance, taste, odor, texture, mouthfeel and physicochemical properties of similar products of animal origins (meat products). Plant-based meat substitutes are made of either plant proteins or from mammalian proteins which are produced and expressed in non-animal systems under controlled conditions in laboratories, eliminating the need to slaughter or mistreat animals. In the context of the present invention, animal proteins (myoglobin) are expressed in plant cell cultures. The plant cells are modified to produce the end products, which may be any type of meat products, such as steak substitute, meatloaf substitute, schnitzel substitute, entrecote substitute, sausage substitute, hot dogs substitute, pastrami substitute, shish kebab substitute, kabab substitute, salami substitute, bacon substitute, meat balls substitute, shawarma substitute, hamburger substitute, patty substitute, kabanos substitute, jerky substitute, ground meat substitute, roast meat substitute, minced meat substitute, pulled meat substitute, skewered meat substitute, raw meat substitute, smoked meat substitute, grilled meat substitute etc. In other words, the end products (the meat substitutes) comprise both myoglobin and plant materials and ingredients.

As used herein, the term “meat substitute/alternative/analogue” refers to any consumable product or foodstuff, which is not made from animal, parts or derivatives thereof, and is meant to replace animal-based products in one's diet by attempting to mimic or equal the nutritional values, or organoleptic/physicochemical properties of the animal-based products.

As used herein, the term “conventional meat product” refers to a meat product which is produced from an animal source and thus, are not meant to be consumed by vegan or vegetarian populations.

As used herein, the term “hemoprotein/hemeprotein” refers to a protein which contains a heme group which confers functionality, such as oxygen carrying, oxygen reduction, electron transfer and more. In the context of the present invention, a transgenic hemoprotein, such as myoglobin, hemoglobin, neuroglobin, cytoglobin, or leghemoglobin is expressed in plant cells. The hemoprotein-expressing plant cells are cultured, and them transformed into a powder and a slurry. Said slurry serves as the platform for the production of the plant-based meat substitutes of the present invention.

As used herein, the term “myoglobin” refers to a hemoprotein belonging to the globin superfamily, consisting of eight alpha helices connected by loops. Myoglobin binds iron and oxygen, and is found in the skeletal muscle tissue of vertebrates and in almost all mammals. Myoglobin can take the forms oxymyoglobin (MbO2), carboxymyoglobin (MbCO), and metmyoglobin (met-Mb). Myoglobin contains hemes, pigments responsible for the color of red meat. The characteristic color of meat is partly determined by the degree of oxidation of the myoglobin. In fresh meat the iron atom is in the ferrous (+2) oxidation state bound to an oxygen molecule. Cooked meat is brown because the iron atom is now in the ferric (+3) oxidation state. In the context of the present invention, transgenic myoglobin (of an animal origin) is expressed in plant cell culture. The culture is transformed into a powder and then a slurry, which can be the basis for downstream processes for generating meat substitutes, such as steak, loaf, schnitzel, sausage, hot dogs, pastrami, shish kebab, kabab, meat balls, shawarma, hamburger. Myoglobin sequence from any known mammalian source can be transformed to- and expressed in the plant cell culture disclosed in the present invention to generate meat substitutes.

As used herein, the term “plant cell suspension culture” refers to cells grown in laboratory equipment, under controlled conditions, usually outside their natural environment, isolated from their original tissue. Single cells or small aggregates of cells are allowed to function and multiply in an agitated growth medium, thus forming a suspension of cells. The cells in the suspension can either be derived from a tissue or from another type of culture. In the present application the cells in the suspension culture are preferably carrot cells.

As used herein, the term “slurry” refers to a mixture of solids denser than water suspended in liquid. In the context of the present invention, the slurry comprises disrupted plant cells which are genetically engineered to express myoglobin. Therefore, the slurry contains myoglobin expressed by the cells, and all the intracellular components and content of the plant cells (including fibers, proteins, sugars, pigments, antioxidants etc.)

As used herein, the term “transgenic or recombinant proteins” refers to the expression of proteins through the creation of genetic sequences in a laboratory and introducing them to a system/organism capable of expressing them in mass quantities. In the context of the present invention, transgenic myoglobin of a mammalian origin is amplified in a laboratory and transformed into plant cells (for example, by means of electroporation or agroinfiltration). Subsequently, only cells which successfully absorbed the sequence of the mammalian myoglobin (coupled with a selective gene conferring antibiotic resistance) will be able to survive and multiply and to continue expressing myoglobin.

As used herein after, the term “organoleptic properties” refers to the numerous aspects of foodstuffs, beverages or other substances that create an individual sensory experience such as mouthfeel, taste, sight, smell, texture or touch. The meat substitutes of the present invention exhibit organoleptic properties which are equivalent or similar to conventional meat products. In other words, the product of the present invention may look, smell and taste like non-vegan meat foodstuffs. Moreover, the products of the present invention have the characteristic textures of non-vegan meat products in terms of consistency and firmness.

As used herein after, the term “physicochemical properties” refers to unique physical and chemical properties of a consumable product, which describe among other things, its strength, firmness, tightness, resilience, rheological parameters, moisture content, viscosity, adhesiveness, cohesiveness, fracturability, elasticity, chewability, springiness. degradation rate, solvation, porosity, surface charge, functional groups etc. The physicochemical properties are responsible for the behavior of the product under different environmental and internal conditions, and they determine for example, the product's shelf life, appearance, resistance to stress, interactions with external ingredients, texture and many other aspects.

As used herein after, the term “nutritional values” refers to the measure of essential nutrients, such as fats, proteins, carbohydrates, minerals and vitamins in foodstuffs and beverages. In terms of nutritional values, meat products are rich in proteins, a variety of fats including omega-3 polyunsaturated fatty acids and some vitamins and minerals, such as B12, folic acid, zinc, iron, selenium, potassium, magnesium, and sodium. Despite their high nutritional values, the consumption of some meat products (mainly fat parts, or grilled or smoked dishes) has been associated with elevated risks of having cardiovascular diseases, various forms of cancers and metabolic disorders. The reasons for this are numerous and may be explained by the different preparation processes and the environmental conditions under which the animals were grown (for instance, antibiotic residues and microbial contaminations may be directly or indirectly transmitted from the animal to the consumer). The meat substitute of the present invention is also enriched with nutritional values as it contains high content of protein (myoglobin), in addition to the naturally occurring, beneficial ingredients found in the plant cells in which said myoglobin is expressed. Furthermore, the meat substitute of the present invention might even comprise enhanced nutritional values compared to conventional meat products, as it is an industrial product, whose ingredients can be manipulated (meaning that ingredients such as vitamins, minerals and amino acids can be potentially added to the formulations of the substitute products to fortify their nutritional values).

The present invention provides a method for producing plant-based meat substitutes, made of recombinant myoglobin protein expressed in plant cells. The disclosed system is preferably a carrot cell suspension culture. The present application discloses the expression and use of bovine myoglobin, but this is a non-limiting example, and any other type of heme-containing protein (hemeprotein) can be used to produce the disclosed plant-based meat substitutes following the description of the present application.

Meat products are among the most consumed foodstuffs around the world, owing their popularity and palatability to high levels of protein, vitamin B and minerals and to varying fat contents. The decision to purchase and consume meat products is mainly attributed to their flavors, appearance and juiciness. The flavor of beef was found for example, to be as important or even more important to American consumers than the meat's tenderness (see “Beef customer satisfaction: Role of cut, USDA quality grade, and city on in-home consumer ratings.” Neely, T. R. et al., Journal of Animal Science, 76(4), 1027-1033, 1998″).

The unique flavors of meat products are provided by different contents of amino acids and nucleotides, whereas volatile compounds contribute to diverse aromas.

Raw meat is described as salty, metallic and rare (bloody) with a slight sweet aroma. It is weakly-flavored, however it constitutes a rich source of compounds which are precursors of volatile compounds. Heat treatment of meat initiates a series of reactions that result in the development of the characteristic flavor of meat. These reactions are multi-directional and include: Maillard reaction, lipid oxidation, interactions between the products of Maillard reaction and lipid oxidation, as well as thiamine degradation and more. Heat treatment of lean meat imparts non species-specific meaty flavor, whereas warming up meat which contains fat, especially phospholipids and to a lesser extent triglyceride, causes the development of species-specific flavors.

Thousands of volatile compounds are generated during thermal processing, belonging to various chemical classes: hydrocarbons, alcohols, aldehydes, ketones, carboxylic acids, esters, lactones, furans, pyrans, pyrroles, pyrazines, pyridines, phenols, thiophenes, thiazoles, thiazolines, oxazoles and other nitrogen or sulfuric compounds. The species-specific flavors of meat are determined by combinations of volatile compounds which in the case of heat-treated products may include even a few hundreds of compounds, e.g. ca. 880 of volatile compounds were identified in cooked beef.

The invention of alternative meat products using plant-based ingredients is not a novelty. For several decades, the food industry has been focused on developing plant-based foods with the organoleptic properties characteristic to meat. With the appearance of textured vegetable proteins, it was possible to generate products having textures very similar to those of animal origins. However, the flavors and aromas of animal meat cannot be as easily achieved, as they are the result of chemical reactions of multiple precursors of volatile organic components.

Although it is possible to find sugars and fatty acids in plant sources similar to those found in animal origins, the amino acid profile of the peptides present in vegetable proteins substantially differs from the peptides derived from mammalian proteins.

One of the most important protein in terms of organoleptic properties for beef products is myoglobin. Myoglobin is a sarcoplasmic protein, responsible for the transport and storage of oxygen within muscle tissue. It is formed by a single polypeptide chain of about 17,800 of molecular weight, attached to a heme group. Myoglobin was the first protein whose three-dimensional structure was determined in 1957, a milestone in biochemistry for which its discoverer, John Kendrew, was awarded a Nobel Prize. The structure of myoglobin is highly compact, with about 75% of the folded chain found in the form of alpha helices, and with a quaternary structure maintained primarily by hydrophobic bonds. The heme group is located at the cavity of the molecule. Myoglobin is the main pigment in meat, and the color of meat products fundamentally depends on the state in which myoglobin is found. In muscle tissues, iron is found in the myoglobin in the form of ferrous ion (Fe′ and this is also how it is found in fresh meat. The heme group can be oxidized, thus forming the bright red oxymyoglobin, which is observed on the exterior surface of meat. Inside the tissue, myoglobin is not attached to oxygen, thus being in the deoxymyoglobin form, which is characterized by more intense and darker purple-red color than oxymyoglobin. These two forms are interconvertible, depending on the partial pressure of oxygen, and in practice, on the contact surface. Under the conditions of normal atmosphere, the ferrous ion is unstable, shifting to ferric ion (Fe′). In myoglobin, the structure of the heme group and the protein chain protect the ferrous ion, however oxidation does occur, especially if the contact surface is large, as in the case of processed meat. Meat juiciness is also affected by myoglobin. The red fluid that often accumulates in the packaging of red meat or appearing on the surface during cooking of the meat is not blood (most of the blood is removed during processing and the remaining blood is usually found in muscle tissues), but a mixture of water and myoglobin that are expulsed due to the dehydration of cells.

The current application discloses a transgenic myoglobin protein expressed in plant cell suspension culture, for the formulation of alternatives to meat products, composed entirely from plant-based ingredients.

In a preferred embodiment of the present invention, any hemoprotein can be expressed in the plant cell suspension culture disclosed herein for the production of meat substitutes. These hemoproteins are for example myoglobin, hemoglobin, neuroglobin, cytoglobin, or leghemoglobin.

In a preferred embodiment of the present invention, myoglobin proteins are expressed and produced in carrot cell suspension culture for the formulation of plant-based meat substitutes. The meat substitutes of the present application may be generated using different carrot (Daucus sativus) varieties and cultivars, such as: Snow White, Kurodagosun, Chantenay Red Core, Danvers, Kintoki, Autumn King, Trophy, Amstrong, Flakkee, Nantes, Saint Valery, Brasilia, Emperador, Nerac, Larga Cordobesa, DH1, Nevis F1, Nantaise, Yukon, Amsterdamse Bak, Touchon, Coral, Muscade, and any other lines, varieties or cultivars known in the art, whether they are wild type plants, hybrid plants, progeny of crossing and breeding techniques or genetically engineered plants (transgenic plants or plants whose genome is modified or edited by molecular methods such as CRISPR/Cas). Nowadays, many carrot varieties and cultivars are available in a range of different colors, reflecting a varying spectrum of substances, pigments, vitamins, minerals and antioxidants with scientifically proven beneficial properties. The meat substitutes of the present invention originate from a slurry of plant cells expressing myoglobin proteins. Said slurry is a pivotal component of the end product (the meat substitutes), hence, conferring further valuable nutritional values to the meat substitutes. For example, if the slurry is made of purple carrot cells expressing myoglobin, then the final product is enriched with minerals and vitamins characteristic to all carrots (potassium, manganese, vitamin C and vitamin A), but is also rich in anthocyanins, which are abundantly found in purple fruits and vegetable.

In yet another preferred embodiment of the present invention, cells from other plant species, which are rich in nutritional values, such as sweet potato (Ipomoea batatas), beetroot (Beta vulgaris), tomato (Solanum lycopersicum), cassava (Manihot esculenta), kohlrabi (Brassica oleracea var. gongylodes), parsley root (Petrosehnum crispum), horseradish (Armoracia rusticana), Jackfruit (Artocarpus heterophyllus), rice (Oryza sativa), tobacco (Nicotiana tabacum), potato (Solanum tuberosum), and Anchusa officinalis can be used to express transgenic myoglobin proteins and serve as the platform for the production of the plant-based meat substitutes of the present invention.

In another preferred embodiment of the present invention, the plant cells (in a suspension culture, in a powder form, in a slurry or as the final plant-based meat substitute) express at least of the following genetic sequences disclosed in the present application: SEQ ID NO:1, and SEQ ID NO:2.

In yet another preferred embodiment of the present invention, the plant-based meat substitutes are characterized by having the distinct organoleptic properties (mainly flavor, texture, color and aroma) and physicochemical properties (firmness, juisiness) associated with conventional meat products from animal origins.

In yet another preferred embodiment of the present invention, the plant-based meat substitutes have nutritional benefits which are not to be found in conventional animal-based products, such as high level of carotenoids, a unique fatty acid pattern and no cholesterol, as the carrot cells serving as the production system are also utilized as nutritional ingredients incorporated into the final plant-based meat substitutes.

In yet another preferred embodiment of the present invention, the myoglobin-containing plant-based slurry may be shaped, molded, modified, processed, cut, sliced or chopped into different types of meat dishes, such as steak, meatloaf, schnitzel, entrecote, sausage, hot dogs, pastrami, shish kebab, kabab, salami, bacon, meat balls, shawarma, hamburger, patty, kabanos, jerky, ground meat, roast meat, minced meat, pulled meat, skewered meat, raw meat, smoked meat, grilled meat etc. Additionally, the plant-based meat substitutes of the present invention might mimic the characteristic flavor of different types of animals, such as cows, pigs, sheep, goats, deer, horses, chickens etc. depending on the source of the hemoprotein and the food additives supplemented to the meat substitutes.

In yet another preferred embodiment of the present invention, flavoring, spices and seasonings can be added and incorporated to the plant-based meat substitutes disclosed herein to further enhance meaty, smoked, grilled or roasted flavors and aromas. Such spices and seasonings may include, in a non-limiting way, paprika, black pepper, white pepper, turmeric, herb blends, breadcrumbs Baharat, Cajun seasoning, chimichurri blend, Garam Masala, Ras el-hanout, curry, gumbo powder, harissa, zaatar, cumin, berbere, Adobo Seasoning, chili, BBQ seasonings etc. Flavorings that might be added to the plant-based meat substitute of the present invention to enhance its meaty flavor are for example: glucose, ribose, cysteine, succinic acid, dextrose, sucrose, thiamine, glutamic acid, alanine, arginine, asparagine, aspartate, glutamine, glycine, histidine, isoleucine, leucine, lysine, methionine, phenylalanine, proline, threonine, tryptophan, tyrosine, valine, guanosine monophosphate, inosine monophosphate, lactic acid, creatine, sodium chloride and potassium chloride.

In yet another preferred embodiment of the present invention, the plant cells of the disclosed application expressing myoglobin proteins, can be spray-dried and kept for several weeks without being kept frozen.

In yet another preferred embodiment of the present invention, a slurry of plant cells expressing transgenic myoglobin can be kept for a predetermined period of time at a predetermined temperature (room temperature, refrigerated or frozen for longer periods), and then be used to generate different meat substitutes, such as steak, loaf, schnitzel, entrecote, sausage, hot dogs, pastrami, salami, bacon, jerky, shish kebab, kabab, meat balls, shawarma, hamburger, ground meat, roast meat, minced meat, pulled meat, skewered meat, raw meat, smoked meat, grilled meat etc. Each production process is different and requires several distinct modifications and molding to the proper form and size, but for all products, the same myoglobin-containing plant cell slurry is utilized.

### Example 1

Experimental Design for the Expression of Bovine Myoglobin in Carrot Cell Suspension Cultures.

A. Development of Fast-Growing Carrot Cell Lines for the Accumulation of High Amount of Biomass.

Different varieties and cultivars of carrot (Daucus carota) where assayed for the establishment of fast growing in vitro cultured cell lines. The meat substitutes of the present application may be generated using different carrot varieties, for instance: Snow White, Kurodagosun, Chantenay Red Core, Danvers, Kintoki, Autumn King, Trophy, Amstrong, Flakkee, Nantes, Saint Valery, Brasilia, Emperador, Nerac, Larga Cordobesa, DH1, Nevis F1, Nantaise, Yukon, Amsterdamse Bak, Touchon, Coral, Muscade, and any other lines, varieties or cultivars known in the art.

Seeds were surface sterilized by soaking in water overnight at 4° C., dipping in 70% ethanol for 1 min and soaking in a 20% bleach solution for 5 min, and then rinsed 5 times in sterile distilled water. The seeds were germinated on half-strength Murashige and Skoog (MS) medium with 0.25% sucrose and 0.8% agar (pH 5.8) at 26° C. and under cool-white fluorescent lights (450 μmol m⁻² s⁻¹, 16 h day/8 h night).

When the length of the hypocotyls was around 1 cm long, seedlings were removed, petioles and hypocotyls were excised, and 2-3 mm length segments were used for the induction of calli formation.

Explants were placed on callus induction plates (3.2 g/L Gamborg B5 basal medium, 0.5 g/L IVIES (2-(N-morfolino) ethanesulfonic acid), 2% sucrose, 0.7% agar, pH 5.7, and supplemented with 1 mg/L 2,4-dichlorophenoxyacetic acid (2,4-D), 0.1 mg/L kinetin once autoclave sterilized. Plates were incubated at 26° C. and under cool-white fluorescent lights (450 μmol m⁻² s⁻¹, 16 h day/8 h night) and calli formation monitored during 3-4 weeks.

Fresh calli of pale-yellow color and friable (approximately 0.3-0.5 g) were removed from induction plates and used as inoculum to start liquid cultures in 50 mL erlenmeyers containing 10 mL of carrot cell culture induction medium (3.2 g/L Gamborg B5 basal medium, 0.5 g/L IVIES (2-(N-morfolino) ethanesulfonic acid), 2% sucrose, pH 5.7, and supplemented with 1 mg/L 2,4-D (2,4-dichlorophenoxyacetic acid), 0.1 mg/L kinetin once autoclave sterilized. Cultures were incubated with agitation at 130 rpm, 26° C. and under cool-white fluorescent lights (450 μmol m⁻² s⁻¹, 16 h day/8 h night). Initiated cell lines were initially self-cultured every 7-10 days using 30%-40% of inoculum. Once cell lines tolerated self-culture every 7 days, inoculum was sequentially reduced to adapt cells to fast growth. If the carrot variety used for the disclosed system is for example, Snow white, then cell lines are maintained by self-culturing using 15% inoculum every 7 days in induction medium.

B. Obtaining Plasmid Constructs for the Expression of Bovine Myoglobin in Carrot.

To express myoglobin (MGB) in the context of the present application, the coding region of bovine (Bos taurus) myoglobin sequence (NM_173881.2, SEQ ID NO:1) was codon optimized for its expression in carrot (Daucus carota) (SEQ ID NO:2). Both wild type and codon optimized MGBs (MGB_{wt} and MGB_{DC} respectively) were ordered as synthetic genes cloned into pDonr221™ plasmid to obtain pDonor-MGB_{wt} and pDonor-MGB_{DC}. Using the Gateway™ LR Clonase™ Enzyme mix (Thermo Fisher Scientific), the sequences were transferred to the following plant binary vectors: (i) pB7WGF2, obtaining pB7-GFP:MGB_{wt} and pB7-GFP:MGB_{DC}, vectors for the expression of WT and carrot optimized MGB fused from their amino terminal part to Green fluorescent protein (GFP); and (ii) pK2GW7, obtaining pK2-MGB_{wt} and pK2-MGB_{DC}, vectors made for the expression of carrot optimized untagged bovine MGB in carrots cells. Both constructs express the gene of interest under the control the CaMV 35S constitutive promoter and 35 terminator sequences.

pB7-GFP:MGB_{DC} and pK2-MGB_{DC} plasmids were transferred by electroporation to Agrobacterium tumefaciens GV3101 strain electrocompetent cells and transformants were selected by incubation on rifampicin (25 μg/mL), gentamicin (100 μg/mL) and spectinomycin (50 μg/mL) containing Luria Broth agar plates during 48 hs at 28° C.

C. Transient Expression of Bovine Myoglobin in Nicotiana benthamiana Leaves

Transient expression of bovine myoglobin was performed by agroinfiltration into N. benthamiana leaves. Selected A. tumefaciens harboring pB7-GFP:MGB_{DC} and pK2-MGB_{DC} where grown under proper antibiotic selection on LB medium overnight at 28° C. with 180 rpm agitation. Cultures were harvested by centrifugation, resuspended in water to a final OD_{600 nm} of 0.3 and infiltrated into the abaxial side of the leaf, using a syringe without needle. Leaves agroinfiltrated for the expression of GFP tagged MGB were observed under epifluorescence microscope at 2-3 days post agroinfiltration (dpai). Both GFP tagged MGBs (WT and DC optimized) accumulate at the cytoplasm and nucleus. Observation at cortical planes of the cells indicate that the protein remains soluble, without accumulating at any obvious subcellular structure and follows the acto-myosin driven cytoplasmic streaming. The carrot optimized MGB accumulates to much higher levels than the WT version and its accumulation is sustained at least during 7 dpai. The expression, size, and integrity of the myoglobin were confirmed by western blot. For that, total protein extraction was performed and detected using both anti-GFP antibody (3H9, Chromotek) and anti-myoglobin MGB (MAB97201, R&D Systems) monoclonal antibodies as primary antibodies. Horseradish Peroxidase (HRP) conjugated anti Rat (7077S, CST) and HRP conjugated anti-mouse (sc-2005, SCB) were respectively used as secondary antibodies. Chemiluminescent reagent was used for developing. Similarly, untagged MGB was analyzed by W. blot using anti-myoglobin, confirming its expression and accumulation at 4 and 7 dpai.

D. Transformation of carrot cell lines for the constitutive expression of bovine myoglobin Carrot cells were transformed by co-culture with A. tumefaciens strain GV3101 harboring pK2-MGB_{DC} plasmid. Agrobacteria was grown over night on LB medium supplemented with proper antibiotics (rifampicin, gentamicin and spectinomycin at 25, 100 and 50 μg/μl respectively), harvested by centrifugation at 5000×g during 10 min and resuspended to an OD_{600 nm}=0.2 in carrot induction medium supplemented with 200 μM acetosyringone and incubated for 2 h at 22° C. 10 mL of exponentially growing carrot cells were vacuum filtered onto a filter paper disc until liquid was removed. The disc was inoculated with 500 μl of induced agrobacteria. The mixture was then co-cultured on plates containing plant cells medium without antibiotics, at 25° C. and on the dark. After 3 days, co-cultured cells were harvested and transferred to 15 mL sterile tubes, washed 3 times with 10 mL of plant cells medium containing cefotaxime (250 μg/mL) and kanamycin (100 μg/mL). For every wash, cells were centrifugated at 400×g during 5 min and supernatant discarded. The pellets at each wash were resuspended by gently agitation. After the last wash, cells were resuspended in 10 mL medium, and 1.0 mL was poured on agar plates containing carrot cells medium supplemented with cefotaxime to eliminate remaining bacteria and kanamycin to select transgenic resistant cell lines.

Plates were incubated in the dark at 25° C. for 3-5 weeks and monitored periodically for the presence of calli. Calli were harvested and cultured on plates containing kanamycin (100 μg/mL). Approximately 0.3-0.5 g of calli belonging to each transformation event were used to initiate liquid cultures in 50 mL erlenmeyers containing 10 mL of carrot cells medium supplemented with kanamycin (100 μg/mL). Transgenic cell lines were self-cultured every 7 days under selection conditions and assayed for the accumulation of bovine myoglobin. Cell lines accumulating high levels of the transgenic protein were selected and used for subsequent protein characterization.

E. Batch Fermentation

For batch fermentation, a 6-liter glass vessel bioreactor with a working volume of 4.0 L was used. Temperature was maintained at 27° C. using a water jacket. The bioreactor was equipped with oxygen and pH probes to monitor their respective levels. Mixing was carried out using four blade impellers at 100 rpm during the growth phase. The aeration rate was achieved using a compressor, and it was maintained constant at 200 ml/min for the proliferation phase. The bioreactor was loaded with about 8.5 g (fresh weight) of an inoculum of the carrot cell lines with constitutive expression of bovine myoglobin, whose size ranged between 100 and 500 μm. The growth medium was identical to that used for the cultures in the Erlenmeyer flasks. The reaction was conducted under a photoperiod of 16 hours (the maximum fluence rate was 25 μmol m⁻² s⁻¹). During the growth phase, silicon was added to avoid formation of foam on the surface of the suspension. For the determination of the growth curve, samples from the culture were taken, and a known volume was filtered through a GF/A filter (Whatman) under a reduced pressure. The recovered cells were weighed, and then dried for 24 h at 80° C. to determine the dry weight. The growth rate (u) was calculated during exponential growth as the slope of a linear regression of the In (dry weight) versus time. The doubling time (Td) was based on the growth rate where Td=0.693/L. The results show a u=0.462 and a Td=1.5 days.

### Example 2

Following the protein expression process described in the above example, all cellular materials from the bioreactor are harvested by vacuum filtration. Subsequently, the wet carrot cells were resuspended in an aqueous buffer that adjusts the pH to 7.2. In addition, the buffer contains EDTA (Ethylenediaminetetraacetic acid, a chelating agent), ascorbic acid (antioxidant), polyvinyl pyrrolidone (polyphenol scavenger), Triton X-100 (detergent) and maltodextrin (carrier). The buffer volume is large enough to achieve a dry matter content of 45%. First, the maltodextrin and all the other additives are dissolved using a shear disperser (Ultra Turrax 50, IKA, Germany) for about 10 min at 7000 rpm at 25° C.

The carrot cell suspension was spray-dried in a pilot scale spray dryer (Anhydro Lab S 1, Denmark) equipped with a two-fluid nozzle which was installed for a co-current spray drying process. To produce spray-dried particles with various size ranges, the total dry matter of the suspension is 45% (w/w), as well as the atomizing pressure of the spray nozzle of 2 bar(g) were adjusted according to a 22 factorial design with a center point at 1.5 bar(g) atomizing pressure and 45% (w/w) dm in the suspension. The inlet air temperature was set at 195° C. In order to retain the outlet air temperature at 80° C. during each trial, the feed rate was adjusted by the speed of the attached peristaltic feed pump. 1,500 g of suspension was dried in each run at a feed flow rate of 30-42 g/min. Samples were collected from the sampling container, which is installed after the cyclone. The powder yield was determined as the ratio of collected powder from the sampling container to the theoretical total dry matter of the atomized suspension. The highest yield reached at the trials was 88%. The powder product can be stored at 25° C. up to six months, maintaining its functionality.

Unlike other recombinant food protein expression platforms, such as yeasts, plant cells have a thick wall composed of cellulose fibers that allows them to act as a beneficial encapsulation system. This cell wall confers resistance against conditions of physicochemical, enzymatic and oxidative stresses. Carrot cells can be dried by spray drying allowing a longer life as a food ingredient. It was previously reported that a spray-dried product of carrot cells contained up to 80% of the carotenoid content even after 12 weeks of storage at 35° C.

The present application aims at obtaining ingredients (carrot cells that contain transgenic bovine myoglobin) that can be dried by spray-drying while maintaining the viability of the expressed transgenic proteins, and simultaneously can be stored and transported at 25° C., without refrigeration. This feature is significantly advantageous compared to yeast-based platforms, which do not support spray-drying and must be frozen and kept in this state during storage. Commercially, keeping dried, frozen yeast-based products is highly unprofitable, since these products must be consumed almost immediately after the end of the production process. On the other hand, the transport of frozen food ingredients is also not a commercially viable technique.

Due to the absence of a cell wall, yeasts cannot protect the proteins found inside them from thermal and oxidative stresses caused by the process of spray drying. Therefore, companies that use this expression platform, must break the cells once the protein expression process is finished, and follow one of the following paths:

Directly applying the yeast protein extract to the food formulation. This should be done immediately after partial purification.

Alternatively, freezing the protein extract could be carried out, which should prolong the ingredients' shelf life for a few weeks. However, the conservation of large volumes in a frozen form is a highly expensive industrial practice and therefore not recommended.

Lastly, the protein extract can be lyophilized, which allows the manufacturers to have a powder product lasting for several weeks. However, lyophilization is a very expensive process reserved practically only for the pharmaceutical industry.

Hence, companies that use yeasts as an expression platform inevitably need to have fermentation capacities in each country which they intend to market in, limiting their capacity for commercial expansion.

Unlike yeast-based platform, plant cells have a cell wall, which is a structure characterized by a high lignin content, especially carrot cells. The fiber content allows carrot cells to be excellent protein carriers. Many investigations have been carried out to use carrot cells for oral delivery of therapeutic proteins, due to their ability to protect the proteins inside them from oxidative stress and enzymatic digestion caused by the stomach and digestive tract (see “Protein delivery into plant cells: toward in vivo structural biology.” Cesyen Cedenyo et al. Front Plant Sci. 2017; 8: 519, 2017). Similarly, carrot cells can protect the proteins inside them from the oxidative damage caused by the spray drying process.

Obtaining recombinant proteins in vegetable cells capable of being spray dried while still preserving the integrity of the proteins, allows exportation of foodstuffs and ingredients from the country of production to any part of the world.

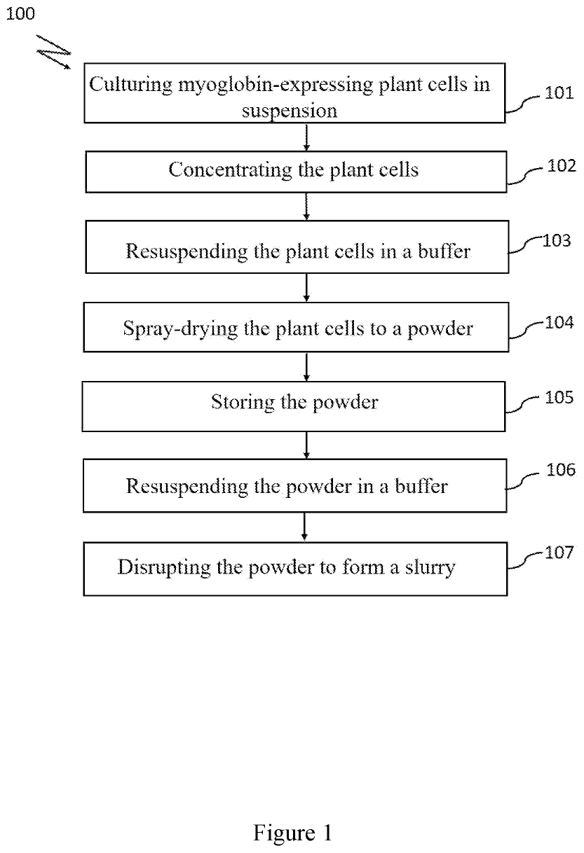

Reference is now made to FIG. 1. schematically depicting the method for preparing the slurry which is used for the production of the plant-based meat substitutes disclosed in the present application. First, plant cells (preferably carrot cells) which are genetically manipulated to express bovine myoglobin are suspended in a culture (101), with optimal conditions allowing them to multiply. Once a sufficient amount of plant cells is obtained in the culture, the suspension is concentrated by any concentration means known in the art, for example, vacuum filtration or using a membrane (102). Then, the plant cells are re-suspended in a buffer solution (103) and spray-dried (104) until the formation of a fine powder. Subsequently, the powder is stored at a suitable temperature (for carrot cells at about 25° C.) (105) till further use. The following steps are resuspension of the powder in a buffer solution (106), and disruption of the plant cells by means such as homogenization (107) to release ingredients from inside the cells. The carrot cell slurry containing transgenic myoglobin can now be applied to produce the plant-based meat substitutes disclosed in the present application.

### Example 3

To experimentally investigate the plant-based meat substitute of the present application, four types of samples were prepared. The composition of all experimental groups includes the following basic compounds:

| | | CONCENTRATION |
|---|---|---|
| FUNCTION | INGREDIENTS | (%) |
| | Water | |
| Vegetable Protein | Textured Soy Protein | 5.00% |
| Source | Isolated Pea Protein | 15.00% |
| Vegetable Oils | Canola Oil | 14.00% |
| | Coconut Oil | 6.00% |
| | Sunflower Oil | 1.00% |
| | Mixed Tocopherols | 0.100% |
| Thickeners | Methylcellulose | 1.00% |
| | Modified Food Starch | 1.00% |
| | Potato Starch | 0.50% |
| | Maltodextrin | 2.00% |
| | Arabic Gum | 1.00% |
| | Bamboo fibers | 1.00% |

The Control Group samples comprised solely the basic composition.

Group A samples contained the basic composition and additionally the following mixture of additives (Premix of Additives).

| | | CONCENTRATION |
|---|---|---|
| FUNCTION | INGREDIENTS | (%) |
| Amino acids and other | Yeast Extract | 3.00% |
| organic components | Acetic Acid | 0.30% |
| | Succinic Acid | 0.10% |
| Vitamins and Minerals | Sodium Chloride | 0.8000% |
| | Zinc Gluconate | 0.0400% |
| | Thiamine Hydrochloride | 0.0360% |
| | Ascorbic Acid | 0.0400% |
| | Niacin | 0.0050% |
| | Pyridoxine Hydro- | 0.0004% |
| | chloride | |
| | Riboflavin | 0.0004% |
| | Vitamin B12 | 0.0003% |

Group B samples contained the basic composition and additionally 5% carrot cell slurry containing transgenic myoglobin.

Group C samples contained the basic composition, premix of Additives and 5% carrot cell slurry containing transgenic myoglobin.

Manufacturing Procedure

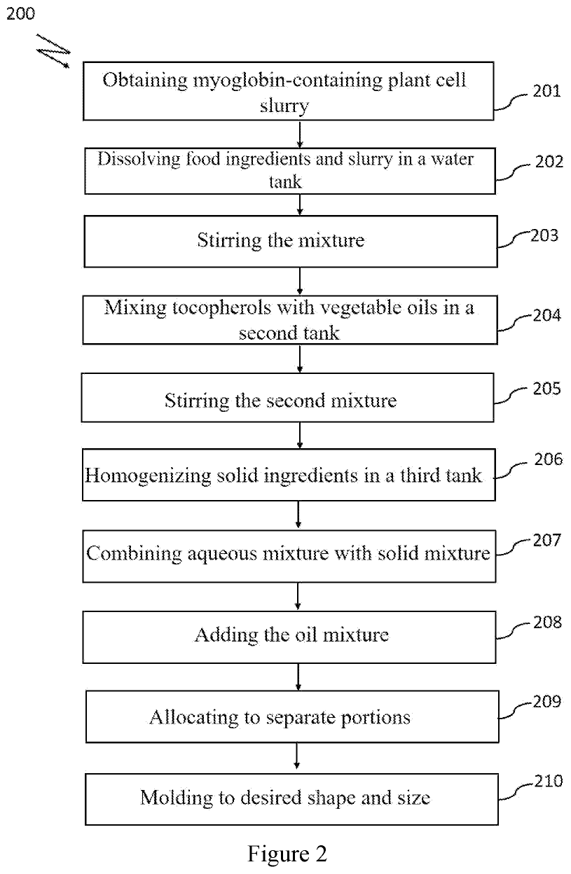

The method (200) and manufacturing processes for the preparation of the plant-based meat substitutes of the present invention are illustrated in FIG. 2. First, a myoglobin-containing plant cell slurry must be produced and obtained as disclosed in FIG. 1 and example 2 (201). Then, a volume of water corresponding to the lot size to be formulated is added to a stirred tank with homogenization capacity. Then, the corresponding quantity of the following ingredients are added and dissolved in the water tank (202): carrot cell slurry containing transgenic myoglobin, and food additives, vitamins, acids, salts and antioxidants, such as yeast extract, acetic acid, succinic acid, sodium chloride, zinc gluconate, thiamine hydrochloride, ascorbic acid, niacin, hydrochloride pyridoxine, riboflavin and vitamin B12. This is the first mixture (aqueous mixture) and it is kept under stirring at room temperature for about 30 minutes (203).

In a separate stirred tank, the corresponding proportions of vegetable oils (such as canola oil, coconut oil, sunflower oil) and mixed tocopherols are added (204). This second mixture is kept under stirring at room temperature for about 30 minutes (205).

In a third container (a solid mixer), the corresponding amounts of solids are added (206): plant proteins (such as textured soy protein and isolated pea protein), methyl cellulose, potato starch, maltodextrin, stabilizers (such as gum Arabic) and fibers (for example bamboo cellulose). The solid ingredients are mixed for one about hour until complete homogenization.

The aqueous solution (first mixture) was then added to the solid mixture (207), while the solid mixer was maintained in homogenization. After about 15 minutes, the mixture of oils and tocopherols (second mixture) was added to the solid mixer, while it continues to work (208). After about 15 minutes the final mixture was separated into portions of 120 gr (209), and the final desired shape of the meat substitute is achieved by pressing on a designated mold (210).

Different molds would result in different shapes and sized, thus, generating different meat substitutes. The final mixture can be used to produce for example, hamburger substitute, steak substitute, meatloaf substitute, schnitzel substitute, entrecote substitute, sausage substitute, hot dogs substitute, pastrami substitute, shish kebab substitute, kabab substitute, salami substitute, bacon substitute, meat balls substitute, shawarma substitute and more. The final portions can be frozen, packed and stored at −20° C. for 6 months till further use.

### Example 4

The present application discloses inventive plant-based meat substitutes, which are also fortified with nutritional ingredients from the carrot cells in which the myoglobin proteins are expressed and produced.

Carotenoids

Carrot cells are enriched with numerous materials, such as vitamin A derivates, the carotenoid pigments.

Carotenoids have been shown to have anti-carcinogenic properties in rats and mice, and it also appears to be the case in humans, especially with head and neck cancers (see “Dietary carcinogens and anticarcinogens”, Ames B. N, Science 221: 1256-1264, 1983 and “Carotenoid Intake from Natural Sources and Head and Neck Cancer: A Systematic Review and Meta-analysis of Epidemiological Studies”, Leoncini E. et al, Cancer Epidemiol Biomarkers Prev. 24 (7): 1003-11, 2015). Carotenoids are also beneficial for dermal and ocular health (see “Discovering the link between nutrition and skin aging”, Schagen S K, Dermato-Endocrinology, 4:3, 298-307, 2012).

Although beta-carotene, which is a type of carotenoids, is currently synthetically produced for commercial use, carrot cell cultures offer an environmentally sustainable, green, safe and highly efficient system to produce important plant metabolites. The beta-carotene content in a carrot cell culture can reach about 1 mg per gr of dry weight.

An additional characteristic of carrot cells as food ingredients is their ability to prolong shelf life of food products due to the presence of both beta-carotene and lycopene. Different studies have shown that the addition of beta-carotene and lycopene to meat and dairy products extends the shelf-life of the product, due to their tendency to minimize lipid oxidation and delay surface discoloration. Additional benefits of the disclosed plant-based meat products are that they are cholesterol-free, since they do not contain any animal fat. Moreover, the daily consumption of carrots has been shown to affect lipid metabolism and reduce cholesterol levels in the blood, mainly due to the fiber content.

To validate the presence and concentration of carotene by the use of myoglobin-expressing carrot cells, the inventors performed an extraction and determination of beta-carotene in the carrot cell slurry of the present invention.

Protocol for the Extraction and Determination of α-Carotene, β-Carotene and Lycopene:

1. 5 g of myoglobin-expressing carrot slurry were weighted and ground with a mortar to obtain a paste.

2. 5 ml of cold acetone (4° C.) were added to the tube and maintained at 4° C. for about 15 minutes with occasional manual stirring.

3. The tube was stirred with vortex at high speed for 10 minutes and then centrifuge at 1370×g for 10 minutes.

4. The supernatant was collected in a separate tube, and 5 ml of cold acetone was added again to the precipitate.

5. Step 4 was repeated and both supernatants were collected into the same tube.

6. The absorbance at 449 nm was measured by using UV-Vis spectrophotometer.

For the determination of the α-carotene, β-carotene and lycopene concentrations, the inventors used the equations reported elsewhere for carrot tissue samples:

$${C}_{α - carotene} ( \frac{mg}{Lt} ) = 7.04 {A}_{443 n m} - 1 0.11 {A}_{492 n m} + 2.06 {A}_{505 n m}$$

$${C}_{β - carotene} ( \frac{mg}{Lt} ) = - 4 \text{.24} {A}_{443 n m} + 1 3.8 {A}_{492 n m} - 6.7 {A}_{505 n m}$$

$${C}_{Lycopene} ( \frac{mg}{Lt} ) = 0.21 {A}_{443 n m} - 1.63 {A}_{492 n m} + 4.18 {A}_{505 n m}$$

Where C_{α-carotene}, C_{β-carotene}, C_{Lycopene} are respectively the concentration of α-carotene, β-carotene and lycopene in mg per liter, and A_{443 nm}, A_{492 nm}, A_{505 nm} are respectively the absorbance at 443 nm, 492 nm and 505 nm.

After analyzing the samples in triplicates, the mean absorbance values obtained were as described in Table 1:

TABLE 1
Mean absorbance values for the determination of
α-carotene, β-carotene and lycopene

| | A_{443 nm} | A_{492 nm} | A_{505 nm} |
|---|---|---|---|
| Carrot cell extract | 3.342 | 2.842 | 2.727 |
| in acetone | | | |

After applying the absorbance values of Table 1 in the above-referenced equations, the following concentrations were calculated:

C_{α-carotene}=0.413 mg/L
C_{β-carotene}=6.448 mg/L
C_{Lycopene}=7.471 mg/L

Taking into count that the wet weight of one sample of carrot cell slurry was 5 gr, the approximate contents of α-carotene, β-carotene and lycopene per gr of wet carrot cell slurry are 0.826 μg, 12.89 μg and 14.94 μg, respectively.

These values indicate that the carrot cell slurry disclosed in the present application and used for the production of various meat substitutes contains high levels of carotenoids. These carotenoids are an added nutritional value to the meat substitutes, as conventional meat products do not naturally contain carotenoids.

Fatty Acids Profile

Overconsumption of saturated fatty acids (SFA) is a struggle for many developed countries, while at the same time most of developing countries suffer from underconsumption of polyunsaturated fatty acids (PUFA), which are considered healthier. According to the Dietary Guidelines for Americans (2015-2020), daily intake of fats should not exceed 20-35% of total acquired energy. Furthermore, not more than 10% of energy should be obtained in the form of saturated fatty acids. Polyunsaturated fatty acids consumption is recommended to constitute 5-10% energy from n-6 and 0.6-1.2% energy from n-3, with not less than 0.5% energy from α-linolenic acid (ALA) and 250 mg per day of eicosapentaenoic acid (EPA) and docosahexaenoic acid (DHA). In turn, most recommended daily intake of conjugated linoleic acid (CLA) for adults is 0.8 gram per day. Generally, the high contribution of animal fat in human diets linked with high cholesterol intake is believed to be associated with the occurrence of diet-related diseases such as coronary diseases.

Glycerolipids are major components of the membrane architecture in plant cells. These acyl lipids are diester of fatty acids (FAs) and glycerol, and the FA moieties can be either saturated or unsaturated. In higher plants, the main species of FAs are 16C and 18C, representing respectively about 30% and 70% of total FAs. These FAs are present with various saturation levels, generally displaying none (16:0, 18:0) to three (16:3, 18:3) double bonds for the main species. In the case of carrot cell culture, the FA profile is ranging as follows: linoleic acid (53-69%), palmitic (27, 32%), linolenic (4-10%), oleic (ca. 6%), and stearic (0-1.8%) acids. The use of carrot cell extracts as a functional ingredient in plant-based food formulation also contributes to a healthier fatty acid profile for the diet.

The inventors carried out a comparative study of the fatty acid profile in a plant-based meat substitute formulated with the myoglobin-containing carrot slurry of the present invention and conventional beef kebab. The analysis was carried out by gas chromatography of fatty acid methyl esters, following the UNE-EN-ISO 12966 method of the Spanish Association for Standardization. The results are presented in Table 2.

TABLE 2
Fatty acid profile in plant-based meat substitute of the
present invention compared to conventional beef kebab

| | Beef | Plant-based meat |
|---|---|---|
| | Kebab | substitute |
| Total Fat (g %) | 19 | 9 |
| Saturated Fat (g %) | 9 | 8.13 |
| Trans Fat (g %) | 0 | 0 |
| Cholesterol (mg) | 90 | 0 |

Fatty Acid Profile

| | | |
|---|---|---|
| Caprylic Acid | <0.1% | 4.0% |
| Capric Acid | <0.1% | 3.9% |
| Lauric Acid | 1.4 | 40.8% |
| Myristic Acid | 3.5 | 18.3% |
| Myristoleic acid | <0.1% | <0.1% |
| Palmitic acid | 32.04 | 10.9% |
| Palmitoleic Acid | 2 | <0.1% |
| Margaric Acid | <0.1% | <0.1% |
| Stearic acid | 23 | 3.1% |
| Oleic acid | 35.92 | 14.4% |
| Linoleic acid | 0.53 | 3.8% |
| Linolenic Acid | 0.53 | 0.6% |
| Arachidic Acid | <0.1% | 0.1% |
| Eicosenoic Acid | <0.1% | 0.1% |
| Arachidonic Acid | 1.08 | <0.1% |
| Behenic Acid | <0.1% | <0.1% |
| Erucic Acid | <0.1% | <0.1% |
| Lignoceric Acid | <0.1% | <0.1% |

Heme-Iron

Proteins are the major source of dietary nutrients. When proteins are digested, amino acids are released to the body for biosynthetic purposes or for generating cellular energy. Besides amino acids, proteins also provide other nutrients, particularly metals. Iron is the most abundant metal in the human body; an adult human subject needs 3-4 gr of iron. Dietary iron is found in two forms, heme and non-heme iron. Heme iron, which is mainly present in meat, poultry and fish, is well absorbed. Non-heme iron, which accounts for the majority of the iron in plants, is not absorbed that well. More than 95% of functional iron in the human body is in the form of heme. Hence, heme should be considered an essential nutrient for humans, although historically, iron is the primary concern in nutrition studies. Particularly, recent studies have shown that heme is efficiently absorbed by the small intestinal enterocytes. In Western countries, heme iron derived from myoglobin and hemoglobin makes up two-thirds of the average person's total iron stores, although it constitutes only one-third of the ingested iron. Evidently, heme is a bona fide essential dietary nutrient. Further, heme directly impacts many physiological and disease processes in humans.

Despite the benefits of a vegetarian diet, followers of such diets are also at a high risk of a deficiency of some nutrients, such as vitamin B12 and iron. In vegetarians, the risk of iron deficiency is related to both inadequate iron intake and low bioavailability of iron from plant foods. Since vegetarians, except for pesco- and semi-vegetarians, do not ingest meats, poultry, or fish, they only consume the less-absorbable non-heme iron found in plant foods. The application of carrot cells expressing myoglobin makes it possible to consume a non-animal source of heme iron. The ingredients and compositions of the inventive plant-based meat substitute of the present invention allow consumption of iron, characterized in greater intestinal absorption compared to iron found in foodstuffs from plant origins.

To validate the heme-iron contribution of the myoglobin-containing carrot slurry of the present invention, the inventors performed iron content analysis in the following samples: (i) a plant-based patty formulated with myoglobin-containing carrot slurry (formulated according to the details disclosed in FIG. 1 and examples 2 and 3); (ii) a plant-based patty containing the same ingredients as sample (i) but without incorporating the myoglobin-containing carrot slurry; and (iii) a commercial veal patty. The analysis was carried out by Atomic Absorption Spectroscopy, according to the recommendations of the methodology N 985.35 of the Association of Official Agricultural Chemist for the determination of iron in food. The results for this analysis are presented in Table 3.

TABLE 3
Iron determination results by AOAC 995.35 Method

| | Iron (ppm) |
|---|---|
| Commercial Veal Patty | 42.9 |
| Plant-based patty without Mb | Not detected |
| Plant-based patty with Mb | 50.9 |

As can be seen from Table 3, the plant-based myoglobin-containing patty substitute of the present invention contains more iron than a commercial patty made from veal.

### Example 5

Analytic Determination of Color and pH of the Plant-Based Meat Substitutes of the Present Invention

Of the several quality attributes of fresh meat, color is the most important one influencing purchase decisions. At the point of sale, consumers, in general, cannot evaluate the odor or feel the texture of meat without opening the packages. Thus, a cherry-red color is commonly utilized as an indicator of wholesomeness of fresh meat. Surface-discolored whole-muscle cuts are ground to low-value products, such as ground beef, to salvage the cuts' interiors, which might still be red, or are discarded often well before microbial safety is compromised; both practices lead to sales loss and wastage of valuable food.

Myoglobin is the sarcoplasmic heme protein primarily responsible for the color of meat obtained from a well-bled livestock carcass. The chemistry and functions of myoglobin in live muscles and meat can be different. In live muscles, myoglobin functions as the oxygen binder and delivers oxygen to the mitochondria, enabling the tissue to maintain its physiological functions. In meats, myoglobin serves as the major pigment responsible for the red color. The cooking process results in denaturation of soluble myoglobin, and heat-induced myoglobin denaturation is responsible for the dull-brown color of cooked meats. Denaturation of the globin exposes the heme group and increases the susceptibility of heme to oxidation. The pigments in cooked meat are coagulated because of the unfolding of the globin chain and therefore, are insoluble in aqueous solutions. Heat-induced denaturation of Met-myoglobin results in denatured globin hemichrome (ferrihemochrome), which is responsible for the dull-brown appearance of cooked meats.

The presence of myoglobin in the carrot cell slurry of the present invention contributes to achieving coloration in the raw product, as well as during the cooking processes. This coloration is similar to meat of animal origin. To validate this assumption, a prototype was prepared following the formulations and methods described in the examples above, and a second prototype was also prepared, using the exact same formulation and steps, but without adding carrot slurry that express myoglobin. In both formulations, measurements of the surface color were performed, prior to- and after the cooking process. In addition, cross-sectional cuts were made at the end of the cooking process, and the interior surface color was determined. To obtain reference values, these same measurements were made on a commercial beef patty.

Color measurement was carried out with a Minolta CM 508-d spectrophotometer, with a 10° angle of the observer, illuminant D65 and excluded specular component.

Cooking Protocol:

1. Take out the patties from the freezer and place on a clean surface where they can thaw.

2. Thaw at room temperature for about 60 minutes total, about 30 minutes for each side of the patty.

3. Place a drizzle of sunflower oil on the electric griddle and spread over the entire surface of the griddle with a napkin so that a thin film of oil covers the entire cooking surface.

4. Preset the electric griddle with a temperature of 204.4° C.

5. Proceed with cooking. Burgers should be cooked until they reach an internal temperature value of 71° C. (approximately 2 minutes on each side).

6. Once the cooking time has elapsed, remove from the grill and taste or allow to cool to room temperature, as appropriate.

The determinations of the external color were performed on the raw samples (Table 4) and cooked sample (Table 5) according to the protocol described. For the cooked samples, the internal color of each sample was determined (Table 6). The CIE (“Commission Internationale de l'Éclairage”, the international commission that defines the parameters for the measurement of color in food) L* a* b* parameters were determined, where L* is the luminosity (L*=100: white; L*=0: black); a* indicates the degree of red or green component (a*>0: red; a*<0: green) and b* the degree of yellow or blue component (b*>0: yellow b*<0: blue). The chroma was also determined: C*_{ab}=(a*²+b*²)^{0.5}, and the tone angle: h_{ab}=arctg (b*/a*), (0°: red; 90° yellow; 180°: green; 270°: blue). In addition, the total color difference ΔE*_{ab}=(ΔL*²+Δa*²+Δb*²)^{0.5} was determined. The differences were calculated to determine the total color difference of each sample with respect to the commercial meat hamburger. Differences between samples and cooking methods were determined through an analysis of variance (ANOVA), and difference between means through Tuckey's multiple range test (p<0.05). To measure pH values, the methodology reported by Kirk, Sawyer and Egan was followed. A potentiometer was calibrated with the pH 4, pH 7 and pH 10 regulatory solutions according to the users' manual. Subsequently, 10 g of each sample was mixed with 40 ml of deionized water and liquefied in a homogenizer. Finally, the electrode was immersed in the suspension and after the potentiometer stabilization the pH value was recorded.

The results of pH before and after the cooking process, are shown in Table 7.

TABLE 4
External color of raw samples

| Sample | L* | a* | b* | C*_{ab} | h_{ab} | ΔE*_{ab} |
|---|---|---|---|---|---|---|
| Commercial Beef | 51.57 ± | 12.05 ± | 19.71 ± | 23.11 ± | 58.55 ± | — |
| Patty | 1.26^{c} | 0.74^{a} | 0.96^{b} | 0.99^{b} | 1.79^{b} | |
| Plant-based | 46.17 ± | 17.51 ± | 18.72 ± | 25.67 ± | 47.19 ± | 8.64 ± |
| substitute | 3.49^{b} | 2.52^{b} | 1.19^{b} | 2.46^{c} | 3.26^{a} | 2.09 |
| without | | | | | | |
| myoglobin | | | | | | |
| Plant-based | 37.25 ± | 13.65 ± | 15.43 ± | 20.63 ± | 48.64 ± | 15.33 ± |
| patty substitute | 2.89^{a} | 1.67^{a} | 1.31^{a} | 1.91^{a} | 2.93^{a} | 1.86 |
| of the present | | | | | | |
| invention (with | | | | | | |
| myoglobin) | | | | | | |

Different letters in the same column indicate significant differences by the Tuckey test (p ≤ 0.05)

TABLE 5
External color of raw samples

| Sample | L* | a* | b* | C*_{ab} | h_{ab} | ΔE*_{ab} |
|---|---|---|---|---|---|---|
| Commercial Beef | 38.72 ± | 7.08 ± | 13.57 ± | 15.55 ± | 61.13 ± | — |
| Patty | 4.88^{b} | 1.63^{a} | 3.40^{a} | 2.51^{a} | 10.88^{b} | |
| Plant-based | 41.11 ± | 15.19 ± | 24.91 ± | 29.22 ± | 58.45 ± | 14.61 ± |
| substitute | 2.87^{b} | 1.23^{c} | 2.92^{b} | 2.61^{b} | 3.54^{ab} | 2.41 |
| without | | | | | | |
| myoglobin | | | | | | |
| Plant-based | 35.14 ± | 10.44 ± | 13.92 ± | 17.42 ± | 52.98 ± | 6.74 ± |
| patty substitute | 1.07^{a} | 0.60^{b} | 1.44^{a} | 1.25^{a} | 3.00^{a} | 1.04 |
| of the present | | | | | | |
| invention (with | | | | | | |
| myoglobin) | | | | | | |

Different letters in the same column indicate significant differences by the Tuckey test (p ≤ 0.05)

TABLE 6
Internal color of cooked samples

| Sample | L* | a* | b* | C*_{ab} | h_{ab} | ΔE*_{ab} |
|---|---|---|---|---|---|---|
| Commercial | 50.80 ± | 4.22 ± | 15.50 ± | 16.07 ± | 74.77 ± | |
| Beef | 1.59^{b} | 0.52^{a} | 0.52^{a} | 0.70^{a} | 1.66^{b} | |
| Patty | | | | | | |
| Plant-based | 51.81 ± | 14.14 ± | 21.73 ± | 25.96 ± | 56.90 ± | 12.13 ± |
| substitute | 0.78^{c} | 0.76^{c} | 1.12^{c} | 0.67^{c} | 2.59^{a} | 0.41 |
| without | | | | | | |
| myoglobin | | | | | | |
| Plant-based | 46.33 ± | 12.29 ± | 19.88 ± | 23.38 ± | 58.28 ± | 11.41 ± |
| patty | 0.64^{a} | 0.57^{b} | 0.50^{b} | 0.47^{b} | 1.47^{a} | 0.41 |
| substitute | | | | | | |
| of the | | | | | | |
| present | | | | | | |
| invention | | | | | | |
| (with | | | | | | |
| myoglobin) | | | | | | |

Different letters in the same column indicate significant differences by the Tuckey test (p ≤ 0.05)

TABLE 7
pH before and after the cooking process

| | Raw Burger | | | Cooked Burger | | |
|---|---|---|---|---|---|---|
| | | Substitute | Substitute | | Substitute | Substitute |
| | Commercial | without | with | Commercial | without | with |
| | Beef Patty | myoglobin | myoglobin | Beef Patty | myoglobin | myoglobin |
| pH | 5.6 ± 0.5 | 5.5 ± 0.4 | 5.5 ± 0.1 | 6.1 ± 0.2 | 6.0 ± 0.6 | 5.8 ± 0.2 |

The results show that the addition of myoglobin improves coloration of both internal and external parts of the product, in raw and in cooked forms. Regarding the analysis of the raw products, it is evident that the addition of myoglobin makes the value of the a* parameter, which indicates the level of red (the lower the value, the redder the surface tone) decrease to a value close to the animal beef patty's value (13.65 and 12.05, respectively, compared to 17.51 of the plant-based patty that did not contain myoglobin). The statistical approach indicates that there is no significant difference in the red tone on the raw surface between the myoglobin-containing plant-base meat substitute of the present invention and the animal beef patty. The results of external color after the cooking process indicate that the color change in the beef patty and the myoglobin-containing plant-based substitute was similar, and both different from the substitute without myoglobin. Specifically, the a* parameter, both in the beef patty and the myoglobin-containing substitute decreased in the same proportion due to the coagulation of myoglobin, while in the substitute without myoglobin this parameter remained practically the same value. Additionally, the values of the b* parameter, related to the yellow tone (the higher the value, the more yellowish the tone), show lower values in the beef patty and the myoglobin-containing substitute, while the value is higher in the substitute without myoglobin. This is because soy proteins develop a yellowish hue during the cooking process. However, this does not happen when myoglobin is present in the product. Furthermore, the C* parameter, indicative of the level of saturation, showed values without significant differences between the beef patty and the myoglobin-containing substitute.

Regarding the internal color after the cooking process, the results show that due to the internal coagulation of myoglobin, both the beef patty and the myoglobin-containing substitute exhibited a decrease in the value of the a* parameter, while the substitute without myoglobin remained at the same level. This is related to the fact that, in the substitute without myoglobin, the beet extract does not turn brown during cooking, so the reddish tone remains. On the other hand, the ΔE* parameter is lower in the myoglobin-containing substitute, indicating that the total color difference between the beef patty and the myoglobin-containing plant-based substitute of the present invention is lower.

### Example 6

Analytic Determination of the Texture of the Plant-Based Meat Substitutes of the Present Invention

The texture of the samples (described in example 5—beef patty and a myoglobin-containing plant-based meat substitute of the present invention) was determined on cooked samples according to the cooking protocol described in Example 5, with a TA.XT Plus Stable Microsystems Texturometer with a 7.5 cm diameter plate-type aluminum probe, compressing the product by 30% of the original height. The samples were compressed twice at a speed of 1.0 mm/s. Sample temperature for testing: 25° C.

The following physicochemical parameters were determined:

Hardness: Maximum force of the first compression cycle (g). Hardness can be related to the force required to completely break food between the incisor teeth. The hardness value is the maximum force that occurs during the first compression.

Fracturability: It is defined as the force (g) of the first significant peak (where the force decays) before the end of the first compression. Not all products fracture; but when they do fracture, the fracture point occurs where the graph has its first significant peak (where the force drops) during the first compression of the product by the probe.

Adhesiveness: negative area of the first cycle, representing the work required to remove the probe. Adhesiveness can be related to the effort required to separate the food surface from the teeth and palate.

Elasticity: It is the distance to the maximum of the second compression divided by the distance to the maximum of the first compression (mm/mm). Elasticity can be related to the recovery of the sample after compressing it with the tongue against the palate. Elasticity is how well a product physically recovers after it has deformed during the first compression and has been allowed to wait for the target wait time between passes. The elastic recovery is measured on the downstroke of the second compression. In some cases, an excessively long wait time will allow a product to recover more than it could under the conditions under investigation (for example, a human subject would not wait 60 seconds between chews).

Cohesiveness: It is the ratio of positive area of the second cycle and area of the first cycle. Cohesiveness is related to the degree to which the dough remains together after chewing, instrumentally it would be how well the product withstands a second deformation in relation to its strength under the first deformation.

Chewability: It is related to the chewing time of the sample before swallowing.

Resilience: It is the ratio of areas from the first point of inversion of the probe to the crossing of the x-axis and the area produced from the first compression cycle. Resilience is a measure of how well a product can regain its original shape and size.

For the texture measurements, differences between samples were determined through an analysis of variance (ANOVA), and difference between means through the Tuckey multiple range test (p<0.05).

The samples analyzed were the following:

Myoglobin-containing meat substitute: the plant-based patty substitute of the present invention formulated with carrot slurry containing myoglobin as described in the previous examples of this disclosure.

Commercial patty: animal meat patty of a commercial brand.

Following the analysis of the graphs resulting from the texture profile analysis (TPA), the numerical values of Hardness, Fracturability, Adhesiveness, Elasticity, Cohesiveness, Masticability and Resilience were obtained and are shown below in Table 8.

TABLE 8
Texture Profile Analysis

| | Plant-based patty | |
|---|---|---|
| | substitute of the | |
| | present invention | |
| Parameter | (with myoglobin) | Commercial Beef Patty |
| Hardness (g) | 14816.1 ± 2665.49 ^{a} | 12096.3 ± 657.94 ^{a} |
| Fracturability (g) | 13069.4 ± 479.82 ^{a} | 14413.0 ± 2726.54 ^{a} |
| Adhesiveness (g · s) | −6.639 ± 3.13 ^{a} | −2.672 ± 3.13 ^{a} |
| Elasticity | 0.742 ± 0.021 ^{a} | 0.839 ± 0.051 ^{a} |
| Cohesiveness | 0.689 ± 0.006 ^{a} | 0.833 ± 0.013 ^{b} |
| Masticability | 7589.8 ± 1512.63 ^{a} | 8459.81 ± 837.53 ^{a} |
| Resilience | 0.323 ± 0.002 ^{a} | 0.442 ± 0.005 ^{b} |

Different letters in the same row indicate significant differences by the Tuckey test (p ≤ 0.05)

The instrumental analysis of the texture profile shows that the meat substitute of the present invention formulated with carrot slurry containing myoglobin does not significantly differ from the animal meat hamburger in terms of hardness, fracturability, adhesiveness, elasticity and chewiness. Those parameters are described by the relevant technical literature as the most important parameters in describing the sensations during chewing and swallowing. In addition, the differences in cohesiveness and resilience parameters between two products are not large enough to be appreciated on the human palate.

### Example 7

Analytic Determination of Weight and Size of the Plant-Based Meat Substitutes of the Present Invention During Cooking

Generally, beef, poultry, and fish shrink about 25 percent when cooked. The amount of shrinkage will depend on the fat, moisture content, and the temperature at which the meat is cooked. However, shrinking is not a desired behavior. Due to the hygroscopic capacity of myoglobin, it is expected that the incorporation of myoglobin-containing carrot slurry will increase the water retention capacity of the plant-based substitute of the present invention, increasing its yield both in weight and in size.

To validate this theory, measurements of size and weight were performed in substitute products with and without myoglobin, and before and after the cooking process. The measurements were carried out on the plant-based meat substitute formulated according the composition and processes described in the present disclosure, and on a substitute formulated with the same composition but without myoglobin-containing carrot slurry.

Cooking Protocol:

1. Take out the patties from the freezer and place on a clean surface where they can thaw.

2. Thaw at room temperature for about 60 minutes total, about 30 minutes for each side of the patty.

3. Place a drizzle of sunflower oil on the electric griddle and spread over the entire surface of the griddle with a napkin so that a thin film of oil covers the entire cooking surface.

4. Preset the electric griddle with a temperature of 204.4° C.

5. Proceed with cooking. Burgers should be cooked until they reach an internal temperature value of 71° C. (approximately 2 minutes on each side).

6. Once the cooking time has elapsed, remove from the grill and taste or allow to cool to room temperature, as appropriate.

The results of diameter, height and weight are shown below in Table 9.

TABLE 9
Size and Weight Analysis of the plant-based
meat substitutes of the present invention

| | |
|---|---|
| | Plant-based patty |
| Plant-based | substitute of the |
| patty substitute | present invention |
| without myoglobin | (with myoglobin) |

| | Raw | Cooked | Raw | Cooked |
|---|---|---|---|---|
| Weight (g) | 107.14 | 97.37 | 105.63 | 99.83 |
| Diameter (mm) | 90 | 87 | 90.5 | 90 |
| Height (mm) | 17 | 16 | 16 | 16 |

Based on the results shown in Table 9., the inventors performed the calculation of weight loss (WL %), cooking yield (CY %), diameter reduction (DR %) and thickness variation (TV %), using the following equations:

$$W L \% = \frac{W raw - W cooked}{W raw} \cdot 100$$

$$C Y \% = \frac{W cooked}{W raw} \cdot 100$$

$$D R \% = \frac{D raw - D cooked}{D raw} \cdot 100$$

$$T V \% = \frac{T raw - T cooked}{T raw} \cdot 100$$

The results for weight loss, cooking yield, diameter reduction and thickness variation are presented in Table 10.

TABLE 10
Analysis of weight loss, cooking yield, diameter
reduction and thickness variation of the plant-
based meat substitutes of the present invention

| | Product | |
|---|---|---|
| | Plant-based patty | |
| | substitute of the | Plant-based |
| | present invention | patty substitute |
| Parameters | (with myoglobin) | without myoglobin |
| Weight Loss (%) | 5.49% | 9.12% |
| Cooking Yield (%) | 94.51% | 90.88% |
| Diameter Reduction (%) | 0.55% | 3.33% |
| Thickness Variation (%) | 0.00% | 3.33% |

The results of the test carried out verify that the incorporation of myoglobin-containing carrot slurry into the meat substitute of the present invention allows to achieve a meat substitute with better performance after cooking both in weight and size.

### Example 8

Determination of Volatile Compounds in the Plant-Based Meat Substitutes of the Present Invention Using Gas Chromatography/Mass Spectrometry

Flavor is a highly important component of meat eating and there has been much research aimed at understanding the chemistry behind meat flavor, and at determining those factors during the production and processing of meat which influence flavor's quality. The desirable characteristics of meat flavor have also been sought in the production of simulated meat flavorings which are of considerable importance in convenience foods and processed savory foods. Meat flavor is thermally derived, since uncooked meat has little or no aroma and only a blood-like taste. During cooking, a complex series of thermally-induced reactions occur between non-volatile components of lean and fatty tissues resulting in a large number of reaction products. Although the flavor of cooked meat is influenced by compounds contributing to the sense of taste, it is the volatile compounds, formed during cooking, that determine the aroma attributes and contribute most to the characteristic flavors of meat. An examination of the literature relating to the volatile compounds found in meat, reveals that over 1000 volatile compounds have been identified. A much larger number has been identified in beef than the other meats, but this is reflected in the much larger number of publications for beef compared with pork, sheep meat or poultry.

In order to understand which are the precursors that give rise to this great diversity of organic compounds and their relationships with notes of specific flavors and aromas, many studies were carried out by different research groups. Thus, it was possible to understand that aldehydes and ketones contribute ‘fatty’, ‘green’ and ‘mushroom’ odors, a range of heterocyclic compounds, such as thiazoles, thiazolines, pyrrolines and pyrazines contribute ‘roasted’, ‘nutty’ and ‘popcorn’ odors, and also a series of furanthiols and disulfides which confer ‘roasted’ and ‘meaty’ aromas. In combination with other compounds, these substances together are responsible for the characteristic aromas of cooked beef.

An examination of the reaction pathways allows the nature of these precursors to be suggested. Many of the mechanisms responsible for the formation of these compounds have been reviewed previously. Aldehydes and ketones are generally formed by the thermal oxidation of lipids while heterocyclic compounds may be formed by the Maillard reaction between amino acids or peptides and reducing sugars or nucleotides. The furanthiols, with their characteristic meaty aroma, can be formed either by the Maillard reaction with cysteine as the amino acid or from the thermal degradation of thiamine. In summary, most of the scientific references agree that the more relevant precursors related with “meaty” and “roasty” flavors and aromas comes from cysteine, ribose, glutamic acid and succinic acid.

The results of the studies related to the understanding of the chemistry of formation of the components that define the aromas and the flavors of meat, can be applied in the formulation of plant-based foods using vegetable sources of the most important precursors. In this way it is possible to formulate plant-based foods with organoleptic characteristics of animal meat. Despite the contributions of the aforementioned precursors to the formation of volatile organics associated with meat flavors, there are flavors and aromas in roast meat that cannot be generated by these components. As mentioned above, certain aroma and flavor components come from the cross-reactions of precursors with peptides present in animal meat. One of the most important proteins in the supply of peptides that act as precursors in the formation of volatiles in meat is myoglobin. The reaction of peptides derived from myoglobin with other precursors, added to the presence of heme iron, allows the formation of volatile components associated with meatiness, juiciness and liver-like flavor.

In order to validate the contribution of myoglobin expressed in carrot cells, measurements of volatile organic components in aqueous solutions of mixtures of different precursors were carried out by means of Gas Chromatography associated with Mass Spectrometry. The composition of the analyzed solutions is described below in Table 11.

TABLE 11
Compositions of solutions analyzed for volatile compound content

| | | | | | Premix | Premix | Premix |
|---|---|---|---|---|---|---|---|
| | Premix A | Premix B | Premix C | Myoglobin | A + Mb | B + Mb | C + Mb |
| Ribose (mM) | 50 | 100 | — | — | 50 | 100 | — |
| Glucose (mM) | 50 | — | 100 | — | 50 | — | 100 |
| Cysteine (mM) | 100 | 100 | 100 | — | 100 | 100 | 100 |
| Succinic Acid | — | 10 | 10 | — | — | 10 | 10 |
| (mM) | | | | | | | |
| Glutamic Acid | 100 | 100 | 100 | — | 100 | 100 | 100 |
| (mM) | | | | | | | |
| Niacin (Vitamin | 10 | 10 | 10 | — | 10 | 10 | 10 |
| B3) (mM) | | | | | | | |
| The myoglobin- | — | — | — | 1.00 | 1.00 | 1.00 | 1.00 |
| containing carrot | | | | | | | |
| cell slurry of the | | | | | | | |
| present invention | | | | | | | |
| (% m/v) | | | | | | | |

To perform the determination of volatile organic compounds, 10.0 mL of the aqueous solution of each premix were placed in a stainless-steel vial (reactor) and heated in an oil bath to a temperature of 130° C. for a period of about 60 minutes (reaction).

Subsequently, the volatiles present in the “headspace” of the solutions were determined by Solid Phase Microextraction (SPME). For this, the compounds in equilibrium were adsorbed on a Carboxen/Polydimethylsiloxane (CAR/PDMS) fiber (75 μm-SUPELCO) with manual holder, for a period of about 30 minutes at room temperature (23° C.±1° C.). Then, the compounds were desorbed in the injector of the chromatograph at a temperature of 250° C. for about 2 minutes.

Chromatographic analysis was carried out on a Thermo-TRACE 1300 chromatograph equipped with an HP-5 ms column (0.25 μm, 0.25 mm, 60 m). The temperature program and the flow used are detailed below in Table 12:

TABLE 12
Program for chromatographic analysis

| HEAT RATE (° C./min) | TEMPERATURE (° C.) | TIME (minutes) |
|---|---|---|
| | 50 | 5 |
| 15 | 250 | 15 |

| | |
|---|---|
| Flow Rate: 2 ml/min | Injection:Split; split ratio = 10 |

The detection of the compounds at the exit of the chromatograph was performed with a Thermo-ISQ-LT mass spectrometer. The temperature of the transfer line was 270° C. and ionization by electron impact (70 Ev; 275° C.) in full scan mode (35-500 m/z; 0.2 sec).

The identification of the peaks was carried out by comparison with the spectra of the Libraries of the NIST MS Search 2.0 program.

The compounds were listed in order of the retention time (R.T., in seconds), and are designated as having a Zero peak area (0), or a small (S), medium (M), or large (L) average peak area. The list of volatile organic compounds found in Premix A and Premix A with the myoglobin-containing carrot cell slurry is presented in Table 13.

TABLE 13
Volatile organic compounds detected in Premix
A, Myoglobin and Premix A + the myoglobin-
containing carrot cell slurry solutions.

| | | Relative Quantity | | |
|---|---|---|---|---|
| Appex | | Premix | Myo- | Premix A + |
| RT | Organic Compound | A | globin | Myoglobin |
| 2.68 | sarcosine | S | S | S |
| 2.79 | taurine | 0 | S | 0 |
| 2.9 | ethanol | 0 | L | S |
| 3.05 | furan | 0 | 0 | S |
| 3.49 | acetic acid | 0 | 0 | S |
| 3.52 | 2,3-butanedione | 0 | S | 0 |
| 3.66 | 3-methyl furan | S | 0 | L |
| 4.37 | 2, propanone-1 hydroxy | 0 | 0 | S |
| 4.49 | thiophene | M | S | M |
| 4.74 | 2-pentanone | 0 | 0 | S |
| 4.94 | 3 pentanone | 0 | 0 | S |
| 5.02 | 2-ethyl furan | 0 | M | M |
| 5.15 | 2,5-dimethylfuran | 0 | 0 | S |
| 5.3 | 2,4-dimethylfuran | 0 | 0 | S |
| 5.35 | 2,3-dimethylfuran | 0 | 0 | S |
| 5.74 | pyrazine | 0 | 0 | S |
| 6.31 | 4,5-dimethyloxazole | 0 | 0 | S |
| 6.4 | 2,3 dihydro thiophene | 0 | 0 | S |
| 6.61 | 2-methylthiophene | L | 0 | L |
| 6.98 | 4-tert butylphenol | L | L | M |
| 7.17 | hexanal | 0 | L | 0 |
| 7.51 | thiocyanic acid ethyl | L | 0 | M |
| | ester | | | |
| 7.7 | methylpyrazine | 0 | 0 | M |
| 7.73 | 1,3-octadiene | 0 | M | 0 |
| 8.03 | furfural | M | 0 | 0 |
| 8.16 | 2,3-dihydro-5 methyl | 0 | 0 | S |
| | thiophene | | | |
| 8.26 | 2 methyl pyrrole | 0 | 0 | S |
| 8.63 | 2 methyl-3 furanethiol | L | 0 | M |
| 8.68 | 2,4 dimethyl thiophene | | 0 | M |
| 8.86 | 3,4-dimethyl thiophene | S | 0 | 0 |
| 9.03 | 2-heptanone | 0 | L | 0 |
| 9.05 | 2,3-dimethyl thiophene | 0 | 0 | M |
| 9.23 | 2-methyl 3-pentanethiol | M | 0 | M |
| 9.24 | heptanal | 0 | M | 0 |
| 9.35 | 3,3-dimethylbutanoic acid | S | 0 | 0 |
| 9.43 | 2-furfuryl thiol | L | 0 | M |
| 9.55 | 2,3-dimethyl pyrazine | 0 | 0 | M |
| 10.58 | 2,3-octane dione | 0 | S | 0 |
| 10.89 | octanal | 0 | M | 0 |
| 11.41 | 4-hydroxy-5-methyl-3- | S | 0 | M |
| | furanone | | | |
| 11.62 | 2,5-dimethylfuran-3,4- | 0 | 0 | M |
| | dione | | | |
| 12.07 | 2-nonanone | 0 | M | 0 |
| 12.23 | nonanal 3-methyl-2- | 0 | L | 0 |
| 12.56 | thiophenecarboxyaldehyde | 0 | 0 | M |
| 13.24 | 2-decanone | 0 | M | 0 |
| 13.31 | 2-(1-methylethyl)-thiophene | 0 | 0 | S |
| 13.69 | spironolactone | 0 | L | L |
| 16.63 | 3,3-dithio, bis-2-methyl | L | 0 | M |
| | furan 2-methyl-3-[(2- | | | |
| | methyl-3-thienyl) | | | |
| 18.24 | dithio] furan | S | S | S |
| 19.39 | methyl ester of palmitic | L | L | M |
| | acid | | | |

The list of volatile organic compounds found in Premix B and Premix B with the myoglobin-containing carrot cell slurry is presented in Table 14.

TABLE 14
Volatile organic compounds detected in Premix
B, Myoglobin and Premix B + the myoglobin-
containing carrot cell slurry solutions.

| | | Relative Quantity | | |
|---|---|---|---|---|
| Appex | | Premix | Myo- | Premix B + |
| RT | Organic Compound | B | globin | Myoglobin |
| 2.68 | sarcosine | S | S | S |
| 2.79 | taurine | 0 | S | 0 |
| 2.9 | ethanol | 0 | L | S |
| 3.05 | furan | 0 | 0 | M |
| 3.49 | acetic acid | | 0 | M |
| 3.52 | 2,3-butanedione | 0 | S | 0 |
| 3.66 | 3-methyl furan | L | 0 | L |
| 4.37 | 2, propanone-1 hydroxy | 0 | 0 | M |
| 4.49 | thiophene | S | S | M |
| 4.74 | 2-pentanone | 0 | 0 | S |
| 5.02 | 2-ethyl furan | 0 | M | S |
| 5.3 | 2,4-dimethylfuran | 0 | 0 | S |
| 5.74 | pyrazine | 0 | 0 | S |
| 6.27 | 2-cyclopentane-1-methanol | 0 | 0 | S |
| 6.4 | 2,3 dihydro thiophene | 0 | 0 | S |
| 6.61 | 2-methylthiophene | L | 0 | M |
| 6.98 | 4-tert butylphenol | 0 | L | L |
| 7.17 | hexanal | 0 | L | 0 |
| 7.7 | methylpyrazine | 0 | 0 | M |
| 7.73 | 1,3-octadiene | 0 | M | 0 |
| 8.03 | furfural | M | 0 | 0 |
| 8.16 | 2,3-dihydro-5 methyl | 0 | 0 | M |
| | thiophene | | | |
| 8.63 | 2 methyl-3 furanethiol | S | 0 | M |
| 9.03 | 2-heptanone | 0 | L | 0 |
| 9.05 | 2,3-dimethyl thiophene | 0 | 0 | S |
| 9.19 | methoxy phenyl oxime | 0 | | S |
| 9.23 | 2-methyl 3-pentanethiol | M | 0 | 0 |
| 9.24 | heptanal | 0 | M | S |
| 9.35 | 3,3-dimethylbutanoic acid | S | 0 | S |
| 9.43 | 2-furfuryl thiol | L | 0 | 0 |
| 9.55 | 2,3-dimethyl pyrazine | 0 | 0 | M |
| 10.05 | 3-ethyl pyrrole | 0 | 0 | S |
| 10.5 | 2-Thiophenethiol | L | 0 | 0 |
| 10.58 | 2,3-octane dione | 0 | S | 0 |
| 10.89 | octanal | 0 | M | 0 |
| 12.07 | 2-nonanone | 0 | M | 0 |
| 12.2 | Ethyl centralite | M | 0 | 0 |
| 12.23 | nonanal | 0 | L | 0 |
| 13.24 | 2-decanone | 0 | M | |
| 13.69 | spironolactone | 0 | L | L |
| 14.05 | 5-Methyl-1-benzofuran- | M | 0 | 0 |
| | 2-thiol 1-(2,5-Dimethyl- | | | |
| | thiophen-3-yl) | | | |
| 14.2 | propan-2-one | S | 0 | 0 |
| 14.67 | : 3-(Vinylthio) thiophene | S | 0 | 0 |
| 14.7 | Thieno [2,3-b] | M | 0 | 0 |
| | thiophene, 2-methyl- | | | |
| 15.62 | 1,2-Benzenedithiol, | M | 0 | 0 |
| | 4-methyl-2-methyl-3-furyl | | | |
| | 2-oxo-3-butyl | | | |
| 16.35 | disulfide | S | 0 | 0 |
| 16.63 | 3,3-dithio, bis-2-methyl | L | 0 | S |
| | furan 2-methyl-3-[(2- | | | |
| | methyl-3-thienyl) | | | |
| 18.24 | dithio] furan | M | S | S |
| 19.39 | methyl ester of palmitic | S | L | M |
| | acid | | | |

The list of volatile organic compounds found in Premix C and Premix C with the myoglobin-containing carrot cell slurry is presented in Table 15.

TABLE 15
Volatile organic compounds detected in Premix B, myoglobin and Premix
B + the myoglobin-containing carrot cell slurry solutions.

| | | Relative Quantity | | |
|---|---|---|---|---|
| Appex | | Premix | Myo- | Premix C + |
| RT | Organic Compound | C | globin | Myoglobin |
| 2.68 | sarcosine | S | S | M |
| 2.79 | taurine | 0 | S | 0 |
| 2.9 | ethanol | 0 | L | M |
| 3.05 | furan | 0 | 0 | M |
| 3.07 | cefadroxil | M | 0 | 0 |
| 3.52 | 2,3-butanedione | 0 | S | 0 |
| 3.58 | 2-butanone | 0 | 0 | L |
| 3.66 | 3-methyl furan | 0 | 0 | L |
| 3.68 | 2-methyl furan | S | 0 | 0 |
| 4.49 | thiophene | M | S | M |
| 4.74 | 2-pentanone | 0 | 0 | S |
| 5.02 | 2-ethyl furan | S | M | L |
| 5.35 | 2,3-dimethylfuran | 0 | 0 | S |
| 5.54 | 3-methyl pyradazine | 0 | 0 | S |
| 5.57 | 2-Vinylfuran | S | 0 | 0 |
| 6.3 | 4,5-dimethyloxazole | 0 | 0 | S |
| 6.61 | 3-methylthiophene | 0 | 0 | L |
| 6.78 | 2-methyl thiophene | M | | S |
| 6.98 | 4-tert butylphenol | S | L | M |
| 7.17 | hexanal | 0 | L | 0 |
| 7.5 | thiocyanic acid ethyl | 0 | 0 | M |
| | ester | | | |
| 7.7 | methylpyrazine | 0 | 0 | M |
| 7.73 | 1,3-octadiene | 0 | M | 0 |
| 8.16 | 2,3-dihydro-5 methyl | 0 | 0 | S |
| | thiophene | | | |
| 8.6 | 3-ethyl thiophene | 0 | 0 | M |
| 8.62 | Thiophene, 2-ethyl- | S | 0 | 0 |
| 8.68 | 2,5-dimethylthiophene | M | 0 | L |
| 8.83 | 2,3-dimethylthiophene | 0 | 0 | S |
| 9.03 | 2-heptanone | 0 | L | 0 |
| 9.05 | 2,3-dimethyl thiophene | 0 | 0 | M |
| 9.07 | Thiophene, 3,4-dimethyl- | S | 0 | 0 |
| 9.23 | 2-methyl 3-pentanethiol | 0 | 0 | S |
| 9.24 | heptanal | 0 | M | 0 |
| 9.34 | ethyl thiopropionate | 0 | 0 | S |
| 9.44 | 2,5-dimethyl pyrazine | 0 | 0 | S |
| 9.47 | Ethanone, 1-(2-furanyl)- | M | 0 | 0 |
| 9.82 | 4,5-dimethylthiazole | 0 | 0 | S |
| 10.14 | 2,3-dihydro-2,2-dimethyl- | M | 0 | S |
| | benzofuran | | | |
| 10.31 | 2-(1-methylethyl)-thiophene | M | 0 | M |
| 10.5 | 2-Thiophenethiol | L | 0 | 0 |
| 10.58 | 2,3-octane dione | 0 | S | 0 |
| 10.64 | 2,3,4-trimethylthiophene | 0 | 0 | S |
| 10.82 | 2,4,5-trimethyl thiazole | 0 | 0 | L |
| 10.89 | octanal | 0 | M | 0 |
| 11.04 | 5-methyl-2-furan methane | M | 0 | M |
| | thiol | | | |
| 11.76 | 2-thiophen methane thiol | M | 0 | M |
| 12.07 | 2-nonanone | 0 | M | 0 |
| 12.2 | Ethyl centralite | 0 | 0 | 0 |
| 12.23 | nonanal 3-methyl-2- | 0 | L | 0 |
| 12.56 | thiophenecarboxyaldehyde | L | 0 | L |
| 12.76 | 1,2,4-Trithiolane, 3,5- | M | 0 | 0 |
| | dimethyl- | | | |
| 12.84 | 1,2,4-Trithiolane, 3,5- | M | 0 | 0 |
| | dimethyl- | | | |
| 13.01 | N-(2-mercaptoethyl)- | 0 | 0 | M |
| | octanamide | | | |
| 13.24 | 2-decanone | 0 | M | 0 |
| 13.31 | 2-(1-methylethyl)-thiophene | 0 | 0 | M |
| 13.62 | Thieno [3,2-b] thiophene | M | 0 | 0 |
| 13.69 | spironolactone | 0 | L | L |
| 14.05 | 5-Methyl-1-benzofuran-2- | 0 | 0 | 0 |
| | thiol 1-(2,5-Dimethyl- | | | |
| | thiophen-3-yl) | | | |
| 14.2 | propan-2-one | 0 | 0 | 0 |
| 14.67 | 3-(Vinylthio) thiophene | S | 0 | M |
| 15.43 | 1,2,5,6-Tetrathiocane | M | 0 | 0 |
| 15.59 | Thieno [2,3-b] | M | 0 | 0 |
| | thiophene, 2-ethyl- | | | |
| 16.63 | 3,3-dithio, bis-2-methyl | 0 | 0 | S |
| | furan | | | |
| 17.99 | 1,2,4-Trithiolane, 3,5- | M | 0 | 0 |
| | dimethyl-2-methyl-3-[(2- | | | |
| | methyl-3-thienyl) | | | |
| 18.24 | dithio] furan | 0 | S | S |
| 18.5 | [1,2,3,4] Tetrathiane | S | 0 | 0 |
| 19.22 | Thiophene, 2,2′-dithiobis- | S | 0 | 0 |
| 19.39 | methyl ester of palmitic | M | L | L |
| | acid | | | |

The results show that after the heating process, the solutions containing sugar precursors, amino acids and vitamins produce some volatile organic compounds, with only some of them related to aromas and flavors that consumers associate with beef.

However, after the addition of myoglobin and in the presence of the same precursors of sugars, amino acids and vitamins, the profile of volatile organic compounds that are generated following heating is significantly higher, in terms of quantity and relative concentration. In the case of Premix A, the amount of volatile organic compounds after the incorporation of the myoglobin-containing carrot cell slurry increases from 16 to 36 compounds, in Premix B the amount of volatile organic compounds increases from 21 to 28 compounds, while in Premix C the amount of volatile organic compounds increases from 28 to 39 compounds. Most of the compounds generated after the incorporation of the myoglobin-containing carrot cell slurry belong to families of compounds associated with flavors and aromas of meat, according to numerous studies.

The volatile organic compounds generated only in the presence of myoglobin are listed below in Table 16.

TABLE 16
Volatile organic compounds generated only
by the presence of myoglobin-containing carrot
cell slurry of the present invention

| | Organic Compounds | Quantity |
|---|---|---|
| Any Premix + | ethanol | S-M |
| Myoglobin | furan | S-M |
| | 2-pentanone | S-M |
| | 2-ethyl furan | M-L |
| | 2,4-dimethylfuran | S |
| | 2,3-dimethylfuran | S |
| | methylpyrazine | M |
| | 2,3-dihydro-5 methyl thiophene | S-M |
| | 2,3-dimethyl thiophene | S-M |
| | spironolactone | L |
| Premix A + | 2, propanone-1 hydroxy | S |
| Myoglobin | 3 pentanone | S |
| | 2,5-dimethylfuran | S |
| | pyrazine | S |
| | 4,5-dimethyloxazole | S |
| | 2,3 dihydro thiophene | S |
| | 2 methyl pyrrole | S |
| | 2,4 dimethyl thiophene | M |
| | 2,3-dimethyl pyrazine | M |
| | 2,5-dimethylfuran-3,4-dione | M |
| | 3-methyl-2-thiophenecarboxyaldehyde | M |
| | 2-(1-methylethyl)-thiophene | S |
| Premix B + | acetic acid | M |
| Myoglobin | 2, propanone-1 hydroxy | M |
| | pyrazine | S |
| | 2-cyclopentane-1-methanol | S |
| | 2,3 dihydro thiophene | S |
| | methylpyrazine | M |
| | 2,3-dihydro-5 methyl thiophene | M |
| | methoxy phenyl oxime | S |
| | heptanal | S |
| | 2,3-dimethyl pyrazine | M |
| | 3-ethyl pyrrole | S |
| Premix C + | 2-butanone | L |
| Myoglobin | 3-methyl furan | L |
| | 3-methyl pyradazine | S |
| | 4,5-dimethyloxazole | S |
| | 3-methylthiophene | L |
| | thiocyanic acid ethyl ester | M |
| | 3-ethyl thiophene | M |
| | 2,3-dimethylthiophene | S |
| | 2-methyl 3-pentanethiol | S |
| | ethyl thiopropionate | S |
| | 2,5-dimethyl pyrazine | S |
| | 4,5-dimethylthiazole | S |
| | 2,3,4-trimethylthiophene | S |
| | 2,4,5-trimethyl thiazole | L |
| | N-(2-mercaptoethyl)-octanamide | M |
| | 2-(1-methylethyl)-thiophene | M |
| | 3,3-dithio, bis-2-methyl furan | S |
| | 2-methyl-3-[(2-methyl-3-thienyl) | S |
| | dithio] furan | |

The addition of myoglobin to the precursor solutions generates a large number of organic compounds belonging to the pyrazine and pyrrole family (methylpyrazine, 2 methyl pyrrole, 2,3-dimethyl pyrazine, pyrazine, 2,3-dimethyl pyrazine, 3-ethyl pyrrole and 2,5-dimethyl pyrazine). Pyrroles are compounds formed by Strecker degradation and are important as the reactive intermediates for the formation of many highly reactive odoriferous compounds that play important roles in meat flavor, such as pyrazines and aldehydes. The level of pyrazines formed is dependent on reactant conditions, such as moisture content, temperature, pH, and time. Within this group of generated compounds, three related components (2,3-dimethyl-pyrazine, 2,5-dimethyl-pyrazine, and trimethyl-pyrazine) stand out in different studies as the main products of Maillard reactions related to meat flavor. In addition, in a very thorough Thesis work performed by Tanner Jordan Luckemeyer (Texas A&M university, 2015) establishes the relation of incidence of the main organic compound families and the preferences of meat consumers. The results reported in said thesis show that first variable positive influence, accounted for 7% of the variation in overall consumer liking, is provided by benzaldehyde-derived compounds. With the incorporation of the myoglobin-containing carrot cell slurry of the present invention to the meat substitute, it is possible to generate one of the most important benzaldehydes (3-methyl-2-thiophenecarboxyaldehyde). In accordance with the correlation between organic compounds and meat consumers' preferences, the inventors discovered that heptanal (C174) was the third variable to enter the equation and it accounted for 4% of the variation in beef identity. Heptanal among other volatile compounds were found to be associated with roasted, sweet, fruity and fatty odor notes of cooked beef.

Most researchers agree that sulfur compounds are the most important volatiles formed during meat cookery. Sulfur compounds derived from cysteine seem to be particularly important for the characteristic aroma of meat. In the present disclosure, it is demonstrated that the incorporation of transgenic myoglobin to the meat substitute results in the formation of several sulfur compounds, such as 2,3-dihydro-5 methyl thiophene, 2,3-dimethyl thiophene, 2,3 dihydro thiophene, 2,4 dimethyl thiophene, 2-(1-methylethyl)-thiophene, 2,3 dihydro thiophene, 2,3-dihydro-5 methyl thiophene, 3-methylthiophene, 3-ethyl thiophene, 4,5-dimethylthiazole, 2,3,4-trimethylthiophene, 2,4,5-trimethyl thiazole and 2-(1-methylethyl)-thiophene.

Taking into account the diversity of volatile organic compounds generated by the addition of transgenic myoglobin expressed in carrot cells, and its established corresponding correlation with flavors and aromas associated with cooked animal meats, it is concluded that the incorporation of carrot extracts containing transgenic myoglobin alone or together with mixtures of sugars, amino acids and vitamins highly and significantly contribute to meaty and beefy flavors and aromas. In summary, the examples above clearly demonstrate that the plant-based meat substitute of the present invention, containing transgenic myoglobin exhibit organoleptic properties, such as taste, aroma and texture similar or equal to animal meats.

1.-39. (canceled)

40. A plant-based meat substitute comprising:
a. a slurry of transgenic plant cells expressing at least one form of hemoprotein;
b. yeast extract;
c. at least one acid;
d. at least one vitamin;
e. at least one salt;
f. at least one plant protein;
g. at least one saccharide;
h. at least one type of plant fibers;
i. at least one vegetable oil; and
j. at least one food additive,
wherein said plant-based meat substitute characterized as having organoleptic and physicochemical properties characteristic of meat products of animal origin, wherein said plant cells are at least partially characterized as cultured cell lines.

41. The plant-based meat substitute of claim 40, characterized by at least one of the following:
a. said at least one form of hemoprotein is selected from a group consisting of hemoglobin, myoglobin, neuroglobin, cytoglobin, leghemoglobin and any combination thereof;
b. said transgenic plant cells are selected from a group consisting of cell suspension cultures, hairy root cultures, transgenic plants and any combination thereof;
c. said transgenic plant cells are selected from a group consisting of carrot cells, rice cells, beetroot cells, tobacco cells, potato cells, sweet potato cells, tomato cells, Arabidopsis cells, Nicotiana benthamiana cells, cassava cells, kohlrabi cells, parsley cells, horseradish cells, jackfruit cells, Anchusa officinalis cells and any combination thereof;
d. said transgenic plant cells are carrot cells;
e. said at least one acid is selected from a group consisting of acetic acid, succinic acid, ascorbic acid, citric acid, lactic acid, malic acid, tartaric acid and any combination thereof;
f. said at least one vitamin is selected from a group consisting of thiamine, niacin, riboflavin, nicotinamide, pantothenic acid, pyridoxine, folate biotin, vitamin B12 and any combination thereof;
g. said at least one salt is selected from a group consisting of sodium salts, zinc salts, copper salts, magnesium salts, potassium salts, manganese salts and any combination thereof;
h. said at least one plant protein is selected from a group consisting of textured vegetable proteins, isolated plant proteins, cashew, almonds, peanuts, walnuts, brazil nuts, rice, wheat, oat, rye, corn, quinoa, lentil, sesame, chia, pea, chickpea, lupine, soybean, fava bean, mung bean, pumpkin seeds, sunflower seeds, flaxseeds, potato, cassava, yam and any combination thereof;
i. said at least one saccharide is selected from a group consisting of starch, sucrose, dextrose, maltodextrin, fructose, glucose, pectin, steviol and any combination thereof.
j. said at least one type of plant fibers is selected from a group consisting of cellulose, bamboo fibers, flaxseed fibers, banana fibers, Abaca fibers, jute fibers, sisal fibers, pineapple fibers, pea fibers, apple fibers and any combination thereof;
k. said at least one vegetable oil is selected from a group consisting of coconut oil, canola oil, corn oil, olive oil, cottonseed oil, palm oil, peanut oil, sesame oil, soybean oil, sunflower oil and any combination thereof;
l. said at least one food additive is selected from a group consisting of stabilizers, emulsifiers, anticaking agents, flavorings, antifoaming agents, antioxidants, bulking agents, colorants, humectants, preservatives, sweeteners, hydrocolloids, thickeners and any combination thereof;
m. said substitute comprises at least 5 milligrams beta-carotene per 1 Liter;
n. said organoleptic properties are selected from a group consisting of texture, consistency, appearance, taste, odor, flavor, aroma, touch, mouthfeel and any combination thereof;
o. said physicochemical properties are selected from a group consisting of strength, firmness, tightness, resilience, rheological parameters, moisture content, viscosity, hardness, adhesiveness, cohesiveness, fracturability, elasticity, chewability, springiness, degradation rate, solvation, porosity, electrical charge and any combination thereof;
p. said substitute is steak substitute, meatloaf substitute, schnitzel substitute, entrecote substitute, sausage substitute, hot dogs substitute, pastrami substitute, shish kebab substitute, kabab substitute, salami substitute, bacon substitute, meat balls substitute, shawarma substitute, hamburger substitute, patty substitute, kabanos substitute, jerky substitute, ground meat substitute, roast meat substitute, minced meat substitute, pulled meat substitute, skewered meat substitute, raw meat substitute, smoked meat substitute, or grilled meat substitute;
q. said transgenic plant cells, prior to forming said slurry, are configured to be spray-dried into a plant cell powder;

42. The plant-based meat substitute of claim 41, wherein said flavorings are selected from a group consisting of paprika, black pepper, white pepper, turmeric, herb blends, Baharat, Cajun seasoning, chimichurri blend, Garam Masala, Ras el-hanout, curry, gumbo powder, harissa, zaatar, cumin, berbere, Adobo Seasoning, chili, BBQ seasonings, breadcrumbs, glucose, ribose, cysteine, succinic acid, dextrose, sucrose, thiamine, glutamic acid, alanine, arginine, asparagine, aspartate, glutamine, glycine, histidine, isoleucine, leucine, lysine, methionine, phenylalanine, proline, threonine, tryptophan, tyrosine, valine, guanosine monophosphate, inosine monophosphate, lactic acid, creatine, sodium chloride, potassium chloride and any combination thereof.

43. The plant-based meat substitute of claim 41, wherein said antioxidants are tocopherols selected from a group consisting of alpha tocopherol, beta tocopherol, gamma tocopherol, delta tocopherol, synthetic tocopherol and any combination thereof.

44. The plant-based meat substitute of claim 41, wherein said plant cell powder is storable without refrigeration at about 22° C.-28° C. for about 6 months.

45. A method for producing a plant-based meat substitute comprising steps of:
a. genetically transforming plant cells to express at least one form hemoprotein;
b. growing said genetically transformed plant cells in a cell line culture;
c. concentrating said plant cells;
d. resuspending said plant cells in a buffer solution;
e. spray-drying said plant cells to generate a powder;
f. storing said powder at predetermined temperature;
g. resuspending said powder in a buffer solution to obtain resuspended cells;
h. disrupting said resuspended cells;
i. obtaining a slurry of plant cells;
j. admixing said slurry of plant cells with water, yeast extract, at least one acid, at least one salt and at least one vitamin to generate a first mixture;
k. separately admixing at least one plant protein, at least one saccharide, at least one food additive and at least one type of plant fibers to generate a second mixture;
l. combining said first mixture and said second mixture to generate a third mixture;
m. separately admixing at least one vegetable oil and at least one tocopherol with water to generate forth mixture;
n. combining said third mixture with said forth mixture by means of homogenization to generate fifth mixture;
o. portioning said fifth mixture to servings; and
p. molding said servings to desired shapes and sizes,
thereby, producing a plant-based meat substitute characterized as having organoleptic and physicochemical properties characteristic of meat products of animal origin.

46. The method of claim 45, characterized by at least one of the following:
a. said at least one form of hemoprotein is selected from a group consisting of hemoglobin, myoglobin, neuroglobin, cytoglobin, leghemoglobin and any combination thereof.
b. said genetically transformed plant cells are selected from a group consisting of cell suspension cultures, hairy root cultures, transgenic plants and any combination thereof.
c. said genetically transformed plant cells are selected from a group consisting of carrot cells, rice cells, beetroot cells, tobacco cells, potato cells, sweet potato cells, tomato cells, Arabidopsis cells, Nicotiana benthamiana cells, cassava cells, kohlrabi cells, parsley cells, horseradish cells, jackfruit cells, Anchusa officinalis cells and any combination thereof.
d. said at least one acid is selected from a group consisting of acetic acid, succinic acid, ascorbic acid, citric acid, lactic acid, malic acid, tartaric acid and any combination thereof.
e. said at least one vitamin is selected from a group consisting of thiamine, niacin, riboflavin, nicotinamide, pantothenic acid, pyridoxine, folate biotin, vitamin B12 and any combination thereof.
f. said at least one salt is selected from a group consisting of sodium salts, zinc salts, copper salts, magnesium salts, potassium salts, manganese salts and any combination thereof.
g. said at least one plant protein is selected from a group consisting of textured vegetable proteins, isolated plant proteins, cashew, almonds, peanuts, walnuts, brazil nuts, rice, wheat, oat, rye, corn, quinoa, lentil, sesame, chia, pea, chickpea, lupine, soybean, fava bean, mung bean, pumpkin seeds, sunflower seeds, flaxseeds, potato, cassava, yam and any combination thereof.
h. said at least one saccharide is selected from a group consisting of starch, sucrose, dextrose, maltodextrin, fructose, glucose, pectin, steviol and any combination thereof.
i. said at least one type of plant fibers is selected from a group consisting of cellulose, bamboo fibers, flaxseed fibers, banana fibers, Abaca fibers, jute fibers, sisal fibers, pineapple fibers, pea fibers, apple fibers and any combination thereof.
j. said at least one food additive is selected from a group consisting of stabilizers, emulsifiers, anticaking agents, flavorings, antifoaming agents, bulking agents, colorants, humectants, preservatives, sweeteners, antioxidants, hydrocolloids, thickeners and any combination thereof
k. said at least one tocopherol is selected from a group consisting of alpha tocopherol, beta tocopherol, gamma tocopherol, delta tocopherol, synthetic tocopherol and any combination thereof.
l. said at least one vegetable oil is selected from a group consisting of coconut oil, canola oil, corn oil, olive oil, cottonseed oil, palm oil, peanut oil, sesame oil, soybean oil, sunflower oil and any combination thereof.
m. said genetically transforming is executed by means selected from a group consisting of the Agrobacterium-mediated transformation method, particle bombardment, injection, viral transformation, in planta transformation, electroporation, lipofection, sonication, silicon carbide fiber mediated gene transfer, laser microbeam (UV) induced gene transfer, co-cultivation with the explants tissue and any combination thereof.
n. said concentrating of said plant cells is executed by means of vacuum filtration, membrane filtration and any combination thereof
o. said disrupting of said resuspended cells is executed by means of homogenization or mixing.

47. The method of claim 46, wherein said flavorings are selected from a group consisting of paprika, black pepper, white pepper, turmeric, herb blends, Baharat, Cajun seasoning, chimichurri blend, Garam Masala, Ras el-hanout, curry, gumbo powder, harissa, zaatar, cumin, berbere, Adobo Seasoning, chili, BBQ seasonings, breadcrumbs, glucose, ribose, cysteine, succinic acid, dextrose, sucrose, thiamine, glutamic acid, alanine, arginine, asparagine, aspartate, glutamine, glycine, histidine, isoleucine, leucine, lysine, methionine, phenylalanine, proline, threonine, tryptophan, tyrosine, valine, guanosine monophosphate, inosine monophosphate, lactic acid, creatine, sodium chloride, potassium chloride and any combination thereof.

48. A slurry comprising transgenic plant cells expressing at least one form of myoglobin for use in the production of foodstuffs, food ingredients and beverages.
